(19) United States
(12) Patent Application Publication
(10) Pub. No.: US 2018/0071939 A1
(43) Pub. Date: Mar. 15, 2018

(54) SYSTEMS AND METHOD RELATED TO A FOOD-ITEM CUTTER AND ASSOCIATED COVER

(71) Applicant: ZUME Pizza, Inc., Mountain View, CA (US)

(72) Inventors: Alexander John Garden, Tiburon, CA (US); Joshua Gouled Goldberg, Santa Cruz, CA (US); Vaibhav Goel, Santa Clara, CA (US); Julia Collins, San Francisco, CA (US); Robert Eugene Switek, JR., San Andreas, CA (US); Edward Valentin Mills, Livermore, CA (US); Craig Alan Johnson, Livermore, CA (US)

(21) Appl. No.: 15/701,099

(22) Filed: Sep. 11, 2017

Related U.S. Application Data
(60) Provisional application No. 62/394,063, filed on Sep. 13, 2016.
(60) Provisional application No. 62/532,914, filed on Jul. 14, 2017.

(51) Int. Cl. B26D 7/08; B26D 3/24; B26D 7/26; B26D 7/22; B26D 5/04; B26D 5/06

(52) U.S. Cl. CPC B26D 7/088; B26D 3/24; B26D 7/2614; B26D 2007/0018; B26D 5/04; B26D 5/06; B26D 7/22

(57) ABSTRACT

Systems and methods are disclosed for cutting a food item when preparing it to be served to a customer. In some implementations, the cutting system may include a cover that may be used to at least partially surround a portion of a the cutting system. The cover may include one or more doors, drawers, or other movable components that may be used to engage the cutting assembly of the cutting system by activating one or more sensors located along or proximate to the path traveled by the movable component. The movable component may activate the sensor when the movable component has appropriately positioned the food item under the cutting assembly to be cut. Additionally, the cover may include one or more user-engageable switches that may be used to selectively engage cutting assembly when the movable component of the cover is appropriately positioned to be cut by the cutting assembly.

### TECHNICAL FIELD

This disclosure generally relates to technology for a cutting system that cuts and divides food products, and a cover to at least partially surround the cutting system.

### BACKGROUND

### Description of the Related Art

Various items are employed to cut food. Typically a knife includes an elongated blade with a sharpened cutting edge. Rotary knifes are typically employed for cutting pizza. The rotary knife is a disk that is rotatably mounted to a handle, and outer circumference of the disk having a sharpened cutting edge.

Sharpened cutting edges of a blade, either elongated or rotary style may be single beveled or double beveled.

### BRIEF SUMMARY

Cutting food is typically easier with a clean knife than a soiled knife. Some foods tend to soil a knife more than other foods. For example, slicing a hot pizza often leaves melted cheese stuck to the blade of the knife, making it subsequent use of the knife difficult, and increasing the potential for distributing debris from a first food item to a subsequent food item. In addition, knives and other cutting components have sharp edges that may cause serious injury if mishandled.

An apparatus may be summarized as including: a plurality of blades that extend radially from a central axis, each of the blades having a pair of faces opposed to one another across a thickness of the blade, and each of the blades having a cutting edge; a transmission operable to move the plurality of blades between a retracted position and an extended position; and a plurality of wipers radially arrayed with gaps formed between sequentially adjacent ones of the wipers in the array, each of the blades aligned with a respective one of the gaps, the gaps dimensioned to closely receive the respective blades to physically engage the faces of the blade at least on movement of the plurality of blades toward the retracted position thereof from the extended position thereof.

The blades may each include a metal and the wipers may each include a food grade polymer. The transmission may be coupled to drive the plurality of blades as a single assembly along the central axis between the retracted and the extended positions. The apparatus may further include: a plurality of plates radially arrayed with gaps formed between sequentially adjacent metal plates in the array, and wherein each of the wipers may be physically detachably coupled to a respective one of the plates. Each of the plates may be a stainless steel plate and each of the wipers may be a silicone wiper. Each wiper of the plurality of wipers may have a triangular profile with a first set of dimensions, and each plate of the plurality of plates may have a triangular profile with a second set of dimensions, the dimensions of the second set of dimensions smaller than corresponding ones of the dimensions of the first set of dimensions. Each wiper of the plurality of wipers may have a first face and a second face opposed across a thickness of the wiper from the first face, and the pair of faces of each of the blades may be perpendicular to the first and the second faces of a respective pair of the wipers between which the blade passes. Each plate may have a first face and a second face opposed across a thickness of the plate from the first face, and the first face of each of the plates may be perpendicular and adjacent to the second faces of a respective one of the wipers. The plurality of blades may include a first blade that extends through the central axis, and at least a second blade that extends through the central axis, the first and the second blades each having a respective length, the lengths of the first and second blades equal to one another. The plurality of blades may include at least a third blade that extends through the central axis, the third blade having a length, the length of the third blade equal to the lengths of the first and the second blades. The first, the second and the third blades may be nested in one another and a respective bottom-most edge of each of the first, the second and the third blades may be coplanar with one another. A respective bottom-most edge of each of the first, the second and the third blades may reside in a plane that is perpendicular to a direction of motion of the first, the second and the third blades. The apparatus may further include: a frame that supports the plurality of blades and the plurality of wipers above a horizontal surface. The apparatus may further include: a base to support a food item to be cut, the base positionable relatively below the plurality of blades at the extended position of the blades, the base including a number of registration features. The apparatus may further include: a tray to support a food item to be cut, the tray positionable on the base and spaced relatively below the plurality of blades at the extended position of the blades. The tray may include a number of registration features complementary to the registration features of the plate. The tray may include a plurality of channels angularly arrayed about an axis in alignment with respective ones of the blades when the registration features of the tray physically engage the complementary registration features of the base. The apparatus may further include: a piston physically coupled to drive the plurality of blades between the retracted and the extended positions via the transmission at an extended position of the plurality of blades. The apparatus may further include: an electric motor physically coupled to drive the plurality of blades between the retracted and the extended positions via the transmission.

An apparatus may be summarized as including a plurality of blades, each of the blades having a pair of faces opposed to one another across a thickness of the blade, and each of the blades having a cutting edge; a transmission operable to move the plurality of blades between a retracted position and an extended position; and a plurality of wipers arrayed with gaps formed between sequentially adjacent ones of the wipers in the array, each of the blades aligned with a respective one of the gaps, the gaps dimensioned to closely receive the respective blades to physically engage the faces of the blade at least on movement of the plurality of blades toward the retracted position thereof from the extended position thereof. The blades may each include a metal and the wipers may each include a food grade polymer. The transmission may be coupled to drive the plurality of blades as a single assembly between the retracted and the extended positions.

The apparatus may further include a plurality of plates arrayed with gaps formed between sequentially adjacent metal plates in the array, and wherein each of the wipers is physically detachably coupled to a respective one of the plates. Each of the plates may be a stainless steel plate and each of the wipers may be a silicone wiper. At least two of the blades may be parallel to one another. The blades may extend radially from a central axis, the wipers may be radially arrayed with gaps formed between sequentially adjacent ones of the wipers in the array, and the plates may be radially arrayed with gaps formed between sequentially adjacent metal plates in the array. Each wiper of the plurality of wipers may have a triangular profile with a first set of dimensions, and each plate of the plurality of plates may have a triangular profile with a second set of dimensions, the dimensions of the second set of dimensions smaller than corresponding ones of the dimensions of the first set of dimensions. Each wiper of the plurality of wipers may have a first face and a second face opposed across a thickness of the wiper from the first face, and the pair of faces of each of the wipers may be perpendicular to an axis along which the plurality of blades may move between the retracted position and the extended position. Each wiper of the plurality of wipers may have a first face and a second face opposed across a thickness of the wiper from the first face, and at least one of the faces of each of the wipers may be orientated at an angle to an axis along which the plurality of blades may move between the retracted position and the extended position, where the angle may be greater than zero degrees and less than ninety degrees. Each plate may have a first face and a second face opposed across a thickness of the plate from the first face, and the first face of each of the plates may be perpendicular and adjacent to the second faces of a respective one of the wipers. The plurality of blades may include a first blade that extends through the central axis, and at least a second blade that extends through the central axis, the first and the second blades each having a respective length, the lengths of the first and second blades equal to one another. The plurality of blades may include at least a third blade that extends through the central axis, the third blade having a length, the length of the third blade equal to the lengths of the first and the second blades. The first, the second and the third blades may be nested in one another and a respective bottom-most edge of each of the first, the second and the third blades may be coplanar with one another.

A respective bottom-most edge of each of the first, the second and the third blades may reside in a plane that is perpendicular to a direction of motion of the first, the second and the third blades. The plurality of blades may include a first blade that extends outwardly from the central axis without passing through the central axis, and at least a second blade that extends outwardly from the central axis without passing through the central axis and which is diametrically opposed across the central axis from the first blade, the first and the second blades each having a respective length, the lengths of the first and second blades equal to one another. At least one blade of the plurality of blades may be curved about the central axis. At least one blade of the plurality of blades may be curved about an axis that may be perpendicular to the central axis.

The apparatus may further include a frame that supports the plurality of blades and the plurality of wipers above a horizontal surface.

The apparatus may further include a base to support a food item to be cut, the base positionable relatively below the plurality of blades at the extended position of the blades, the base including a number of registration features.

The apparatus may further include a tray to support a food item to be cut, the tray positionable on the base and spaced relatively below the plurality of blades at the extended position of the blades. The tray may include a number of registration features complementary to the registration features of the plate. The tray may include a plurality of channels angularly arrayed about an axis in alignment with respective ones of the blades when the registration features of the tray physically engage the complementary registration features of the base.

The apparatus may further include a piston physically coupled to drive the plurality of blades between the retracted and the extended positions via the transmission at an extended position of the plurality of blades.

The apparatus may further include an electric motor physically coupled to drive the plurality of blades between the retracted and the extended positions via the transmission.

The apparatus may further include a first user engagable input component; and a second user engagable input component spaced from the first user engagable input component by a distance that prevents the first and the second user engagable input components from being concurrently operated by a single hand of a user, the first and the second user engagable input components operably coupled to cause movement of the plurality of blades in response to concurrent engagement of both the first and the second user engagable input components by respective hands of the user. Each of the blades in the plurality of blades may have a cutting edge and the cutting edges of the plurality of blades form a plane, wherein at least one of the blades may be non-linear. At least one of the non-linear blades may form at least one of a letter, logo, or geometrical pattern.

A cover sized and dimensioned to surround a mechanical cutting system that cuts an item, the mechanical cutting system including at least one or more cutting blades, an actuator, and a transmission, the transmission operable to selectively move the at least one or more cutting blades between a cutting position and a retracted position when the actuator is triggered, may be summarized as including a guard-shell that includes at least one wall, the at least one wall separating an interior portion of the cover from an exterior portion, the interior portion having a top region and an opposing bottom region; a platform along the bottom region of the interior portion of the cover, the platform including one or more registration features; an aperture located along the at least one wall of the guard-shell, the aperture sized and dimensioned to allow the item to pass into the interior portion of the cover below at least one of the one or more cutting blades; and a sensor communicatively coupleable to the actuator, the sensor which when activated operably generates a signal and transmits the generated signal to the actuator.

The cover may further include a drawer that selectively moveably translates between an open position and a closed position, the drawer in the closed position located within the bottom region of the interior portion of the cover and the drawer in the open position located at least partially in the exterior portion, the drawer including a bottom, the bottom of the drawer having a upward facing surface that faces towards the top region of the interior portion of the cover, wherein the platform is securely attached to the upward facing surface of the drawer.

The drawer may further include a back wall extending upwards from the top surface of the drawer, the back wall approximately perpendicular to a direction of translation of the drawer, and wherein the back wall is aligned to activate the sensor when the drawer is in the closed position.

The cover may further include an override switch with an ON position and an OFF position, wherein the override switch is operable to cause the cutting assembly remain in the retracted position when the override switch is in the ON position. The drawer selectively may moveably translate between an open position, a closed position, and a cutting position, the drawer in the closed position located within the bottom region of the interior portion of the cover and offset from the cutting blades, and the drawer in the cutting position located within the bottom region of the interior portion of the cover and aligned with the cutting blades.

The drawer may further include a handle, the handle including at least one user-engageable switch having an ON state and an OFF state, the user-engageable switch communicatively coupled to the actuator, wherein the user-engageable switch transmits a signal to engage the actuator when in the ON state.

The cover may further include a solenoid, the solenoid electrically coupleable to the actuator, the solenoid having an ON state and an OFF state, the solenoid in the ON state communicatively coupling the actuator and the sensor, the solenoid in the OFF state communicatively de-coupling the actuator and the sensor.

The drawer may further include one or more registration features, the registration features on the drawer selectively coupleable with one or more registration features on the platform, wherein the platform aligns with the cutting blades when the one or more registration features on the platform are coupled with the one or more registration features on the drawer when the drawer is n the closed position.

The cover may further include a plurality of platforms, each of the plurality of platforms further including one or more registration features, the one or more registration features on each of the plurality of platforms selectively coupleable with one or more registration features on the drawer, wherein each of the plurality of platforms aligns with the cutting blades when the one or more registration features on each of the plurality of platforms are coupled with the one or more registration features on the drawer when the drawer is in the closed position.

The cover may further include a tray, the tray positionable on the platform, the tray including a food receiving portion. The food receiving portion of the tray may align one or more of the cutting blades when the tray is positioned on the platform.

The cover may further include a drawer that selectively moveably translates between an open position and a closed position, the drawer in the closed position located within the bottom region of the interior portion of the cover and the drawer in the open position located at least partially in the exterior portion, wherein the platform forms a bottom surface of the drawer.

The cover may further include wherein the guard-shell includes a front wall having a stationary portion and a movable portion, the movable portion rotatably coupled to the stationary portion along a horizontal axis, the movable portion rotatable between an inward position and an outward position, wherein the movable portion activates the sensor in the inward position.

The guard-shell may further include at least one aperture in the at least one wall, the at least one aperture which aligns with the platform along the bottom region of the interior portion of the cover.

The front wall of the guard-shell may further include a selectively removable portion, the selectively removable portion aligned with the cutting blades in the retracted position.

The cover may further include a display that provides a visual representation of information related to usage of the mechanical cutting system. The information related to usage of the mechanical cutting system may include at least one of a pressure applied to the cutting blades when moving to the cutting position, a number of instances in which the cutting blades have extended to the cutting position since an occurrence of a first defined event, and an amount of time that has elapses since an occurrence of a second defined event. At least one of the first defined event and the second defined event may include an occurrence of a cleaning operation on the cutting blades.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is an isometric view of a cutting system, according to at least one illustrated embodiment.

FIG. 2 is an isometric view of a tray, according to at least one illustrated embodiment.

FIG. 3A is an isometric view of a circular base, according to at least one illustrated embodiment.

FIG. 3B is an isometric view of a square base, according to at least one illustrated embodiment.

FIG. 4 is an isometric view of a portion of a transmission and a cutting assembly, according to at least one illustrated embodiment.

FIG. 5 is an isometric view of a cutting assembly including a plurality of blades and a block, according to at least one illustrated embodiment.

FIGS. 6A-6D are views of each of several blades that may be nestable, according to at least one illustrated embodiment.

FIG. 7 is an isometric view of a block that may be used to hold a nestable set of blades, according to at least one illustrated embodiment.

FIG. 8 is bottom plan view of a cutting assembly in which the blades are positioned to extend radially away from a central axis without passing through the central axis, according to at least one illustrated embodiment.

FIG. 9 is an isometric view of a cutting assembly in which the blades are parallel, according to least one illustrated embodiment.

FIG. 10 is side elevational view of a blade that is curved outward from the cutting block, according to at least one illustrated embodiment.

FIG. 11 shows a bottom plan view of a cutting assembly in which the edges of the blades curve within a plane formed by the edges of the blades, according to at least one illustrated embodiment.

FIG. 12 is an isometric view of a cutting system in which the blades have a curved shape or pattern, according to at least one illustrated embodiment.

FIG. 13 is an isometric view of a cleaning assembly, according to at least one illustrated embodiment.

FIG. 14 is a side elevational view of a pair of opposing wipers engaging a blade at a downward angle such that opposing wipers meet to form a “V” shape, according to at least one illustrated embodiment.

FIG. 15 is a side elevational view of a pair of opposing wipers engaging a blade at an upward angle such that opposing wipers meet to form an upside-down “V” shape, according to at least one illustrated embodiment.

FIG. 16 is a front isometric view of a cover for the cutting system of FIG. 1, according to at least one illustrated implementation.

FIG. 17 is a dotted line, front isometric view of the cover of claim 16 in which a front wall and one side wall have been rendered in dotted line to display an interior portion of the cover, according to at least one illustrated implementation.

FIG. 18 is a front isometric view of a cover that has a drawer that moves between an open position and a closed position with respect to the remaining portion of the cover, according to at least one illustrated implementation.

FIG. 19 shows the cover of FIG. 18 with a portion of a front wall removed to show an interior portion of the cover, according to at least one illustrated implementation.

FIG. 20 is a plan view of an upward-facing surface of a drawer that has a plurality of registration features, according to at least one illustrated implementation.

FIG. 21 is a flowchart that shows a method of operation of a cutting system, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with food preparation devices such as knives, cutters, and other similar devices, closed-loop controllers used to control processing conditions, food preparation techniques, and wired and wireless communications protocols have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

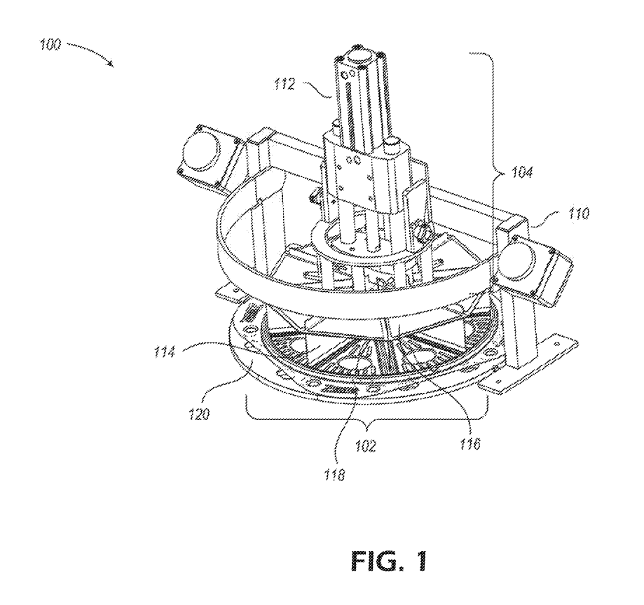

FIG. 1 shows a cutting system 100, according to at least one illustrated embodiment. The cutting system 100 includes a bottom component 102, an upper assembly 104, and a frame 110.

The bottom component 102 may include a base 120, which supports a food item during cutting. Typically, the base 120 will carry “consumable” consumable trays 118 on which a food item is carried, for example cooked or partially cooked food items (e.g., par-baked pizza). The consumable tray 118 may advantageously serve as a bottom portion of packaging in which the food item is at least one of cooked, stored, or shipped. In use, a first consumable tray 118 along with a first instance of a food item may be removed after cutting of the food item, and a new consumable tray 118 along with a second instance of a food item placed on the base 120.

The base 120 may have one or more physical registration features which cooperate with complementary physical registration features on the consumable trays 118. As illustrated, the physical registration features may include apertures in a top surface of the base or plate and complementary buttons that extend from a bottom surface of the tray 118. The physical registration features may of course be reversed, with the buttons extending from the base 120 and the recesses in the tray 118. Alternatively, the base 120 may include one or more recesses and one or more notches and the tray 118 may likewise include one or more recesses and one or more notches. Alternatively or additionally, physical registration features other than recesses and notches may be employed. Physical registration features allow rapid alignment, and may even allow automated equipment (e.g., a robot) to quickly and accurately move consumable trays 118 with food items into and out of the cutting system 100. Physical registration features may advantageously prevent movement of the tray 118 during cutting, including translation and/or rotation.

In at least some implementations, the upper assembly 104 includes at least a transmission 112, a cutting assembly 114, and a cleaning assembly 116. As explained in more detail below, the transmission 112 is coupled to cause the cutting assembly 114 to move between an engaged position or configuration and a disengaged position or configuration. As explained in more detail below, the cutting assembly 114 includes a plurality of knifes or blades which cut the food item, at least when in the engaged position or configuration. As explained in more detail below, the cleaning assembly is positioned to engage the knifes or blades of the cutting assembly 114 at least when passing between the engaged position or configuration and the disengaged position or configuration to automatically or autonomously clean the knifes or blades of the cutting assembly 114 on each pass or use.

The frame 110 may be used to secure or hold components of the bottom component 102 and the upper assembly 104 relative to one another, to facilitate the operation of cutting system 100.

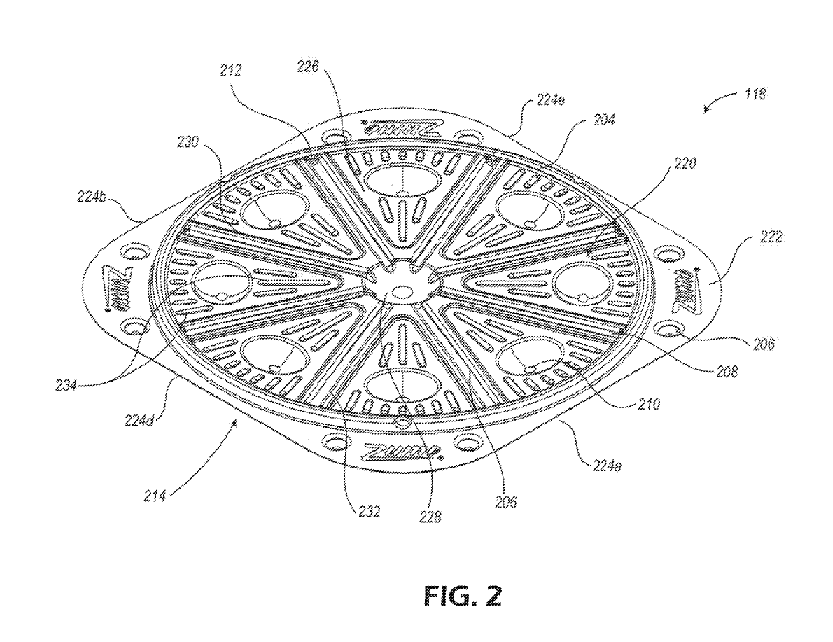

FIG. 2 shows the tray 118 of FIG. 1 in more detail. The tray 118 may have two faces, an upper face 212 and a lower face 214, and may be placed in a horizontal position in which the faces 212 and 214 are roughly parallel to the ground. In this implementation, the tray 118 may support a food item that is to be cut. The illustrated tray 118 shown in FIG. 2 has a configuration that is sized and dimensioned to support a pizza. Other consumable trays 118 may be configured to receive different types of food. The tray 118 may be formed of a single layer of liquid-resistant, insulating, and food safe material including, but not limited to, molded sugarcane fiber (“bagasse”), molded wood fiber, molded bamboo fiber, molded paper or plastic (e.g., biodegradable plastic, thermoplastic material, bio-based plastic, recycled plastic, recyclable plastic). The tray 118 may be opaque, semi-transparent, or transparent (e.g., an opaque base made with molded fiber and a cover made with transparent plastic material). In implementations wherein the tray 118 is formed from molded fibers, the single layer of material may have a relatively small thickness of between 0.5 mm and 1.0 mm (e.g., 0.8 mm). In implementations in which the tray 118 is formed from plastic (e.g., polyethylene terephthalate (PET), poly lactic acid (PLA)), the single layer of material may have a thickness of 0.5-0.6 mm or less.

In some implementations, the tray 118 includes an upwardly facing circular-shaped food receiving portion 220 which receives the pizza thereon. The tray 118 may further include a raised peripheral rim 204 disposed about a perimeter of the food receiving portion 220. The raised peripheral rim 204 comprises a raised upwardly facing apex surface and a downwardly and outwardly extending sidewall which meets with a substantially planar base flange 222 that extends outwardly from the raised peripheral rim 204. The raised peripheral rim 204 may define the shape and size of the food item to be cut or processed. As shown in FIG. 2, for example, the raised peripheral rim 204 may define a circle that can be used for receiving pizza of a certain size. When the raised peripheral rim 204 is raised, it may assist in keeping the food item stationary when the food item is being cut by the cutting assembly 114. The base flange 222 may have a substantially rectangular-shaped (e.g., square) outer perimeter with rounded corners defined by first and second parallel edges 224a and 224b and third and fourth parallel edges 224c and 224d. Among other things, the base flange 222 may strengthen the rigidity of the tray 118.

The food receiving portion 220 of the tray 118 includes a planar surface 226 and a number of features which extend at least one of upward or downward from the planar surface 226. In particular, the food receiving portion 220 includes a central well 228 which extends downwardly from the planar surface 226 and receives liquid drippings or condensation from the cooked food (e.g., pizza) placed on the tray 118. In the illustrated implementation, the central well 228 has a circular perimeter, but may have other shapes (e.g., triangle, octagon) in other implementations.

The food receiving portion 220 may also include a plurality of food receiving portion channels or grooves 208 (also referred to herein as “channels”) extending downwardly below the planar surface 226 and running radially outward from the central well 228 and terminating at the raised peripheral rim 204. In some implementations, the radial channels 208 may extend only partially between the central well 228 and the raised peripheral rim 204. In the illustrated implementation, each of the channels 208 has a U-shaped cross-sectional profile, but in other implementations, the channels may have other shapes (e.g., V-shaped). In some implementations, each channel 208 may slope downward from the raised peripheral rim 204 toward the central well 228 to facilitate the flow of liquid through the channel into the central well. Each pair of adjacent channels 208 and a corresponding portion of the raised peripheral rim 204 delineate a respective sector portion 230 of the food receiving portion 220 which supports a portion of a food item (e.g., an individual slice of pizza). In the illustrated implementation, the tray 118 includes eight channels 208 and eight sector portions 230. Generally the tray 118 may include N channels and N sector portions, where N is a positive integer.

The plurality of channels 208 may be equally radially spaced to allow cutting of the food item (e.g., pizza) into equally sized pieces when cutting assembly 114 cuts the food item. The channels 208 may be positionable relative to the cutting assembly 114 such that each channel 208 is positioned to receive a corresponding feature, e.g., a knife or blade as discussed below, from cutting assembly 114 to cut and thereby process the food item. Because the channels 208 extended downward from the planar surface 226, the cutting assembly 114 may cut through the food item over the channels 208 without damaging (e.g., cutting) the food receiving portion 220 of the tray 118. Further, each of the channels 208 is non-parallel with each of the edges 224a-224d of the tray 118, which may improve the rigidity of the base. In the illustrated implementation, each of the channels 208 is offset by 22.5° from perpendicular from a respective one of the edges 224a-224d which the channel extends toward. Further, each of the channels 208 is collinear with an opposite channel that extends radially in the opposite direction. Thus, when the tray 118 is to be discarded (e.g., composted), the user may fold the base along an axis which extends through two opposing collinear channels to reduce the dimensions of the base so the base will fit within a compost receptacle.

Among other things, the channels 208 may function to strengthen the tray 118 in rigidity and provide supporting forces to the food receiving portion 220 when the tray 118 is disposed on a resting surface, such as a countertop, oven or another food container. The channels 208 may also serve as guides for the cutting assembly 114 to cut eight equally sized pieces of a food item (e.g., pizza). Further, the channels 208 may provide air space below the food item, which provides additional insulation. In some implementations, because the channels 208 may be substantially covered by the food item placed on the food receiving portion 220, indicia (e.g., visible and/or tactile markings) may be positioned on or adjacent the raised peripheral rim 204 radially in line with the channels 208 to aid a user in cutting the food item along the channels. Indicia may also be used by detectors in the cutting assembly to confirm that a tray 118 has been properly positioned on the base 120 so that features on the tray 118, such as the channels 208, are properly aligned with corresponding features in the cutting assembly 114.

As discussed above, each pair of adjacent channels 208 and a corresponding portion (e.g., a 45° arc portion) of the raised peripheral rim 204 may delineate a respective sector portion 230 of the food receiving portion 220 which receives an individual piece of the food item (e.g., slice of pizza). Each sector portion 230 includes a portion of the planar surface 226 and a raised sector portion rim 232 which extends upward from the planar surface 226 and adjacent each of the channels 208 which define the sector portion 230. In addition to supporting the food item above the planar surface 226, the raised sector portion rim 232 adjacent the channels 208 may aid in supporting the food item near the cutting location, thereby facilitating the cutting process to provide accurate individual pieces.

Each sector portion 230 further includes a sector well 210 which may receive liquid drippings from the food product therein. In the illustrated implementation, each sector well 210 has a perimeter rim adjacent the planar surface 226 which has an oval profile. In other implementations, each of the perimeter rims may have a profile in the shape of at least one of a circle, a triangle, a square, another shape, or a symbol (e.g., logo). Each sector portion 230 may also include a plurality of raised sector ribs or projections 234 which extend upward from the planar surface 226 around the sector well 210 having an uppermost portion which supports the hot food product (e.g., pizza). In some implementations, the combined area of the raised sector ribs 234 in a sector portion 230 is smaller than the portion of the planar surface 226 in the sector portion. Thus, when the food product is supported on the uppermost portions of the raised sector ribs 234 and the raised sector portion rim 232, heat loss due to conduction through the planar surface 226 is substantially reduced compared to food containers with flat bottom surfaces which have relatively large surface area contact with the bottom surface of the food product. Additionally, the raised sector ribs 234 and the raised sector portion rim 232 tend to isolate the bottom surface of the food product from the planar surface 226, which prevents the food product from becoming soggy due to trapped liquid on the planar surface 226 of the food receiving portion 220.

In the illustrated implementations, the shapes of the raised sector ribs 234 are elongated and have a length dimension which extends radially with respect to the central well 228. Additionally, in the illustrated implementations the raised sector ribs 234 are radially symmetrical. In other implementations, the number, sizes and dimensions of the raised sector ribs 234 may be different from shown in the figures. The raised sector ribs 234 also function to improve the rigidity of the tray 118.

In some implementations, each of a plurality of features of the tray 118 comprising the raised peripheral rim 204, the central well 228, the sector wells 210, the channels 208, and the raised sector ribs 234 is spaced apart from at least one other of the plurality of features by a distance which is less than or equal to one inch. In some implementations, due to the aforementioned plurality of features, the food receiving portion 220 of the tray 118 does not have a continuously planar surface which exceeds 2 inches by 2 inches. Such features may significantly improve the strength of the tray 118, while allowing the base to have a length dimension greater than 12 inches (e.g., 16 inches), a width dimension greater than 12 inches (e.g., 16 inches), an overall height which is less than 1.5 inches (e.g., 1 inch), and a material thickness between 0.5 mm and 1.0 mm (e.g., 0.8 mm). In other implementations, the tray 118 may have a larger height.

The tray 118 may include one or more registration features 206. The registration features 206 may be used to attach the tray 118 to the frame 110. In doing so, the registration features 206 may be used to properly align the tray 118 with other components, such as the cutting assembly 114 in the upper assembly 104. As shown in FIG. 2, the registration features 206 may include fastening protrusions in the tray 118 that are sized, dimensioned, positioned and/or oriented to align with fastening recesses in the base 120. In some implementations, positioning of the channels 208 may be accomplished using the registration features 206 previously discussed. The fastening recesses may receive the complementary fastening protrusions in the tray 118, thereby securing the tray 118 to the frame 110 or the base 120, respectively.

In some implementations, at least some of the registration features 206, the central well 228, and the sector wells 210 extend downwardly to a lowermost portion of the tray 118 so that they are weight-bearing and function as “feet” which form an insulating air space below the food receiving portion 220 of the tray 118 and a resting surface when the tray 118 is supported on the resting surface. Thus, the raised sector ribs 234 of each sector portion, together with at least some of the registration features 206, the central well 228, and the sector wells 210, form a layer of air insulation between the planar surface 226 of the food receiving portion 220 and the food product and a layer of air insulation between the food receiving portion 220 and a resting surface using only a single layer of material (i.e., the material which forms the tray 118). Additionally, the aforementioned “feet” raise the remainder of the tray 118 slightly above a resting surface (e.g., table), which causes a shadow to be cast, similar to a more formal serving plate.

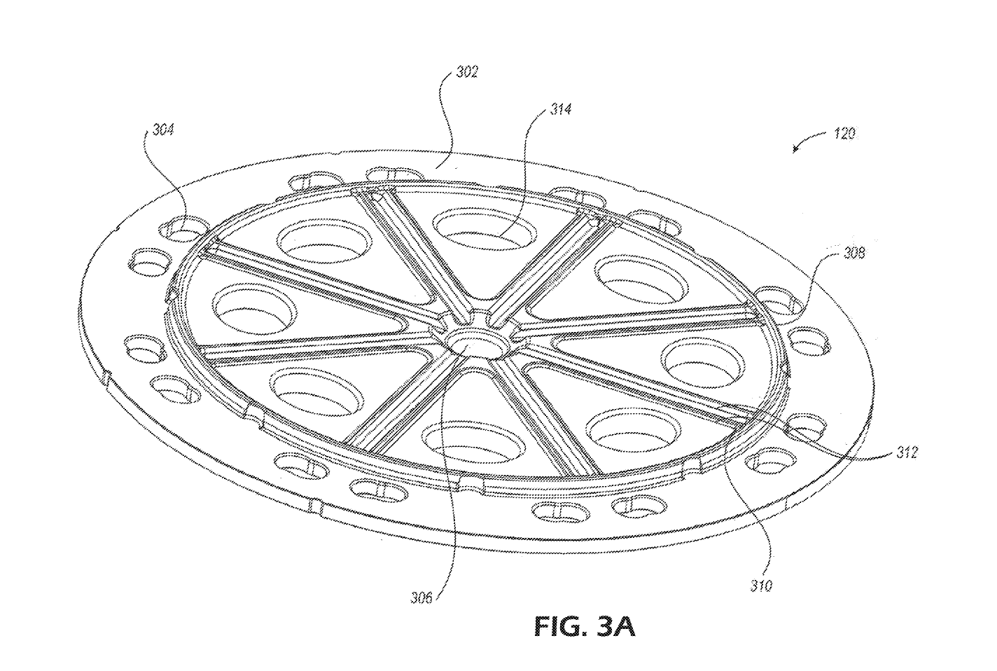

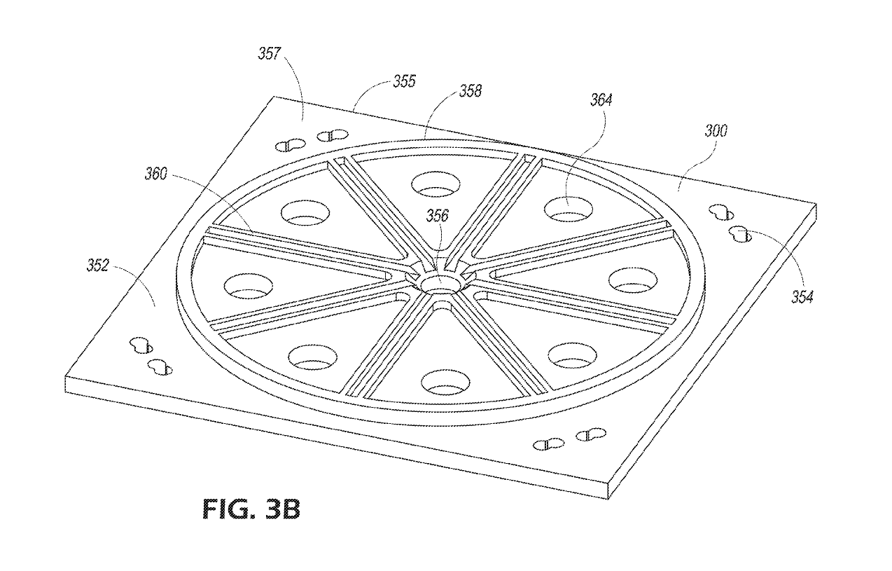

FIG. 3A shows the base 120 of FIG. 1 in more detail. The base 120 may be positioned below the cutting assembly 114 (FIG. 1), and in use carries the tray 118 on which the food item to be cut is carried. The base 120 may have an upper face 302 that is substantially horizontal to the ground. As discussed above, the upper face 302 may have one more registration features 304 that may be used to secure the tray 118 during operation of the cutting system 100. The registration features 304 on the base 120 may be complementary to corresponding registration features 206 on tray 118. The registration features 304 on the base 120 may allow the tray 118 to be positioned relative to the cutting assembly 114. In some implementations, the base 120 may be attached to the frame 110 using, for example, bolts, screws, or other components. In some implementations, a base may be included as a portion of a single integrated frame 110 and base 120. Alternatively, in some implementations, the tray 118 may be attached directly to the frame 110 without the need for a base 120. Hence, the frame 110 may include one or more brackets appropriately placed to provide complementary registration features to the registration features in the tray 118.

The base 120 may have one or more features that are complementary to features in tray 118. For example, as shown in FIG. 3A, base 120 may have a central cavity 306 that may be sized and dimensioned to be slightly larger than, and thus complementary to, a central well 228 in the tray 118. Accordingly, the central well 228 may rest inside the central cavity 306 when the food item is being processed. The base 120 may have a plurality of sector cavities 314 that may be sized and dimensioned to be slightly larger than, and thus complementary to, the sector wells 210 in the tray 118. Accordingly, the sector well 210 may rest inside the sector cavity 314 when the food item is being processed.

The base 120 may have perimeter 308 that forms a circumference around the central cavity 306. The perimeter 308 may be complementary to a raised peripheral rim 204 in the tray 118. Accordingly, the perimeter 308 may have an apex and a downwardly and outwardly sloping sidewall that are sized and dimensioned to be slightly smaller than the corresponding apex and downwardly and outwardly sloping sidewall on the raised peripheral rim 204. In this implementation, the perimeter 308 may provide support to the raised peripheral rim 204 when the food item is being cut by cutting system 100.

The base 120 may have a plurality of grooves 310 that extend radially from the central cavity 306 to the perimeter 308. The grooves 310 may be immediately adjacent to two opposing ridges 312. The grooves 310 and ridges 312 in the base 120 may be sized and dimensioned to be complementary to the channels 208 and the raised sector portion rims 232 in the tray 118. Accordingly, the grooves 310 may be slightly larger than a corresponding channel 208, and the ridges 312 may be slightly smaller than a corresponding raised sector portion rim 232. In such an implementation, the grooves 310 and ridges 312 may provide support and stability for the tray 118 when the food item is being cut by the cutting assembly 114.

As previously noted, the upper assembly 104 may comprise the transmission 112, the cutting assembly 114, and the cleaning assembly 116. One or more of these components may be attached or secured to frame 110 relative to each other and relative to the components in the bottom component 102 to allow the cutting system 100 to cut or process food items.

FIG. 3B shows a square base 350 that has a different shape from the base 120. The square base 350 may include a perimeter 355 that comprises two sets of parallel sides that meet at right angles. As such, an upward-facing surface 357 formed by the perimeter 355 may be square or rectangular in shape, and may include a portion that is configured to register and secure the consumable trays 118, as discussed below. The portion of the bases used to register and secure the consumable trays 118 may be varied to accommodate different shapes and sizes of consumable trays 118. Using the square base 350 having a perimeter with a standardized size or shape may be advantageous, by enabling different bases to be easily, quickly, and efficiently swapped out of the cutting system 100. In addition, the upward-facing surfaces 357 of each of the various square bases 350 may be differently configured to process various sizes, shapes, and types of food items. As such, the square base 350 used within the cutting system 100 may be quickly, easily, and efficiently swapped out, thereby enabling the cutting system 100, for example, to process various types of food items or to have square bases 350 swapped out for cleaning.

The square base 350 may be positioned below the cutting assembly 114 (FIG. 1), and in use carries the tray 118 on which the food item to be cut is carried. The square base 350 may have an upper face 352 that is substantially horizontal to the ground. As discussed above, the upper face 352 may have one more registration features 354 that may be used to secure the tray 118 during operation of the cutting system 100. The registration features 354 on the square base 350 may be complementary to corresponding registration features 206 on tray 118. The registration features 354 on the square base 350 may allow the tray 118 to be positioned relative to the cutting assembly 114.

In some implementations, the square base 350 may be attached to the frame 110 using, for example, bolts, screws, or other components. In some implementations, the components used to securely physically couple the square base 350 to the frame 110 may pass through one or more of the registration features 354 to securely engage with a corresponding receptacle on the frame 110. In such implementations, the registration features 354 may be used to align the square base 350 to be appropriately placed on the frame 110. In some implementations, a base may be included as a portion of a single integrated frame 110 and square base 350. Alternatively, in some implementations, the tray 118 may be attached directly to the frame 110 without the need for a square base 350. Hence, the frame 110 may include one or more brackets appropriately placed to provide complementary registration features to the registration features in the tray 118.

The square base 350 may have one or more features that are complementary to features in tray 118. For example, as shown in FIG. 3B, square base 350 may have a central cavity 356 that may be sized and dimensioned to be slightly larger than, and thus complementary to, a central well 228 in the tray 118. Accordingly, the central well 228 may rest inside the central cavity 356 when the food item is being processed. The square base 350 may have a plurality of sector cavities 364 that may be sized and dimensioned to be slightly larger than, and thus complementary to, the sector wells 210 in the tray 118. Accordingly, the sector well 210 may rest inside the sector cavity 364 when the food item is being processed. In some implementations, one or more of the sector cavity 364 and/or the central cavity 356 may serve as registration features to align the placement of the tray 118 onto the square base 350.

The base 150 may include food-receiving perimeter 358 that forms a perimeter around the central cavity 356. The food-receiving perimeter 358 may be complementary to a raised peripheral rim 204 in the tray 118. Accordingly, the food-receiving perimeter 358 may have an apex and a downwardly and outwardly sloping sidewall that are sized and dimensioned to be slightly smaller than the corresponding apex and downwardly and outwardly sloping sidewall on the raised peripheral rim 204. In this implementation, the food-receiving perimeter 358 may provide support to the raised peripheral rim 204 when the food item is being cut by cutting system 100. The square base 350 may have a plurality of grooves 360 that extend that may be sized and dimensioned to be complementary to the channels 208 and the raised sector portion rims 232 in the tray 118.

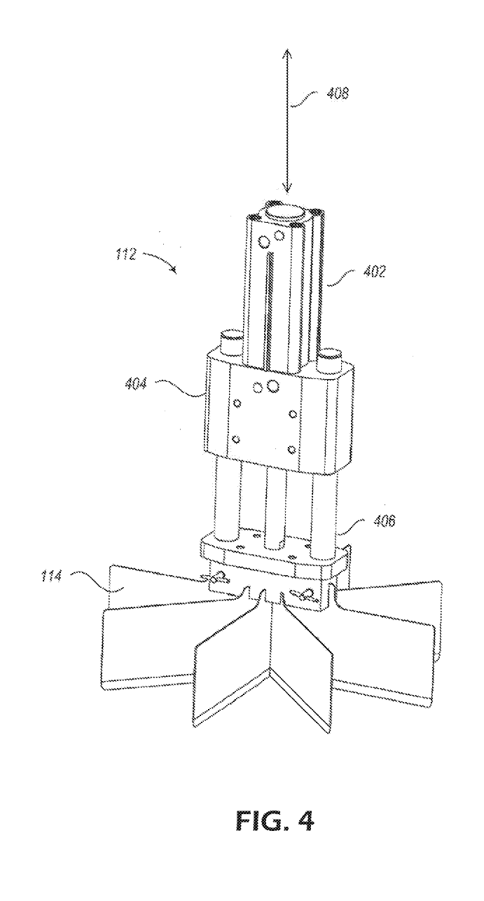

FIG. 4 shows a portion of the transmission 112 and the cutting assembly 114 of FIG. 1 in more detail. In some implementations, the transmission 112 may include a rod 402, an actuator 404, and a plate 406. The actuator 404 may be secured to the frame 110, using, for example, bolts or screws. The rod 402 moves in a direction that is perpendicular to the faces 212 and 214 of the tray 118 and/or base 120. Cutting system 100 uses the motion of the rod 402 to drive the cutting assembly 114 between an up, retracted or disengaged position or configuration, and a down, extended or engaged position or configuration. The blades of the cutting assembly 114 extend through the food item in the down, extended or engaged position or configuration, and the blades are spaced from the food item in the retracted or disengaged position or configuration. The cutting assembly 114 may move (e.g., translate) between a retracted position and an extended position along a central axis 408. In some implementations, the central axis 408 may intersect the tray 118 at a point that is at a center point of the tray 118.

Actuator 404 may be used to apply a force to the rod 402. The force applied by actuator 404 may move the rod 402 along the central axis 408. In some implementations, actuator 404 may be a pneumatic drive (e.g., piston head and cylinder) that uses compressed air or hydraulic fluid to apply a force to the rod 402. In some implementations, the actuator 404 may be an electric motor with gears or a solenoid that may be coupled (e.g., physically, magnetically) to apply a force to the rod 402. In some implementations, the actuator 404 may be comprised of pneumatic valves and switches that function based on directed air flows. In such a situation, the cutting assembly 114 may be fully pneumatic and may require no electrical connections for operation. In some implementations, the actuator 404 may be started or activated by one or more user engagable input components 124, such as buttons, switches, or other control features. For example, user engagable input components 124 (shown in FIG. 1) may be coupled to the actuator 404 to activate the actuator 404. The user engagable input components 124 may be coupled to the actuator 404, for example, by an electrical or a mechanical coupling. In some implementations, multiple user engagable input components 124 may need to be pressed to activate the actuator 404. The cutting system 100 may require multiple user engagable input components to be pressed, for example concurrently pressed, to activate the actuator 404. The multiple user engagable input components 124 can be spaced relatively from one another to require each user engagable input component 124 to be operated by a respective separate hand of the user, ensuring that both hands of the user are on the user engagable input components 124 and away from the cutting assembly during movement of the cutting assembly 114. Further, movement of the cutting assembly 114 may require continuous engagement of the user engagable input components 124 by the user, automatically stopping at least downward movement in response to disengagement of either one or both of the user engagable input components 124 by the hands of the user. Thus, the user engagable input components 124 may provide a safety feature to prevent the cutting system 100 from being accidentally turned on. In some implementations, actuator 404 may be a simple lever arm, and may optionally be biased, for example via one or more springs. In some implementations, a plate 406 may removably attach the cutting assembly 114 to the rod 402. Other components may be used to attach the cutting assembly 114 to the rod 402. In some implementations, the cutting assembly 114 may be directly attached to the rod 402. Accordingly, the force being applied to the rod 402 by the actuator 404 may be transferred to the cutting assembly 114.

The force to be applied by the actuator 404 may depend on the action to be undertaken by the cutting assembly 114. For example, when cutting assembly 114 is being moved into the extended position to cut a pizza, as discussed below, the actuator 404 may apply a force in a downward direction to move the cutting assembly 114. When the cutting assembly 114 is being moved upward into the retracted position, the actuator 404 may apply a force in an upward direction to move the cutting assembly 114.

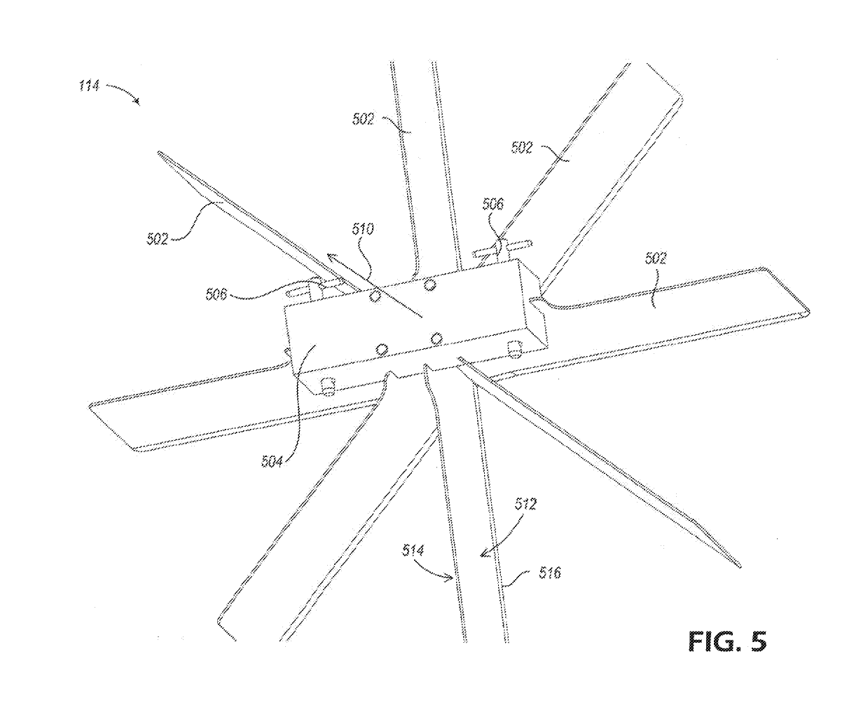

FIG. 5 shows the cutting assembly 114 of FIG. 1 in more detail. Cutting assembly 114 may comprise a plurality of blades 502, a block 504, and optionally fasteners 506. In some implementations, the plurality of blades 502 may be positioned so that the plurality of blades 502 is arranged in relation to a central axis 510, for example angularly arrayed about the central axis 510, and extending generally outwardly from the central axis 510. In some implementations, each blade 502 may be disposed radially (e.g., like spokes from a hub) around a central axis 510. For example, in some implementations, each blade 502 may pass through the central axis 510 such that an approximately equal amount of the blade 502 extends radially from either side of the central axis 510. In this implementation, a cutting assembly with a number N of blades 502 will cut the food item into 2*N pieces. When cutting assembly 114 is operably positioned within cutting system 100, the central axis 510 may be perpendicular to the faces 212 and 214 of the tray 118.

Each blade 502 may have two faces, 512 and 514, disposed on opposite sides of the blade 502. The two faces 512 and 514 may be separated by a distance that may be equal to a thickness of the blade 502. In some implementations, the blade 502 may include a cutting edge or cutting surface 516 that may be used to cut the food item. Each blade 502 may be made of stainless steel or any other material that may be safe and appropriate for processing and cutting food items and easily sanitized. In some implementations, each of the plurality of blades 502 may be the same length.

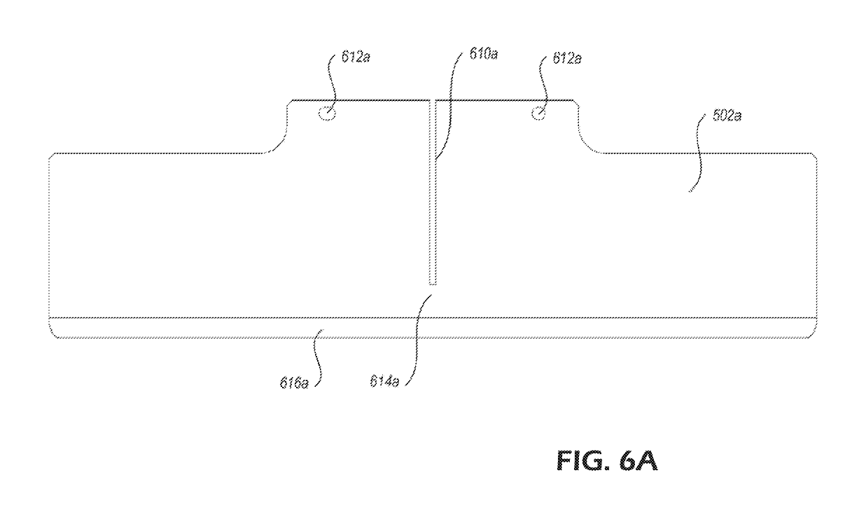

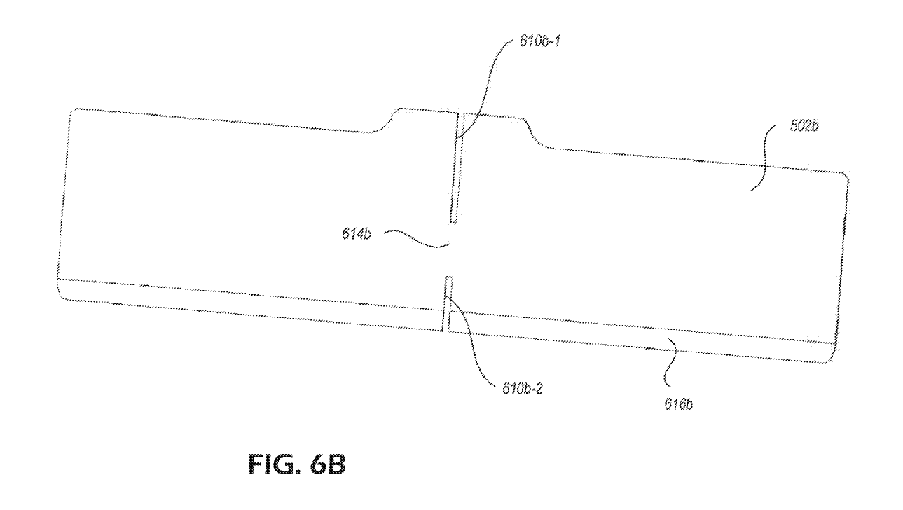

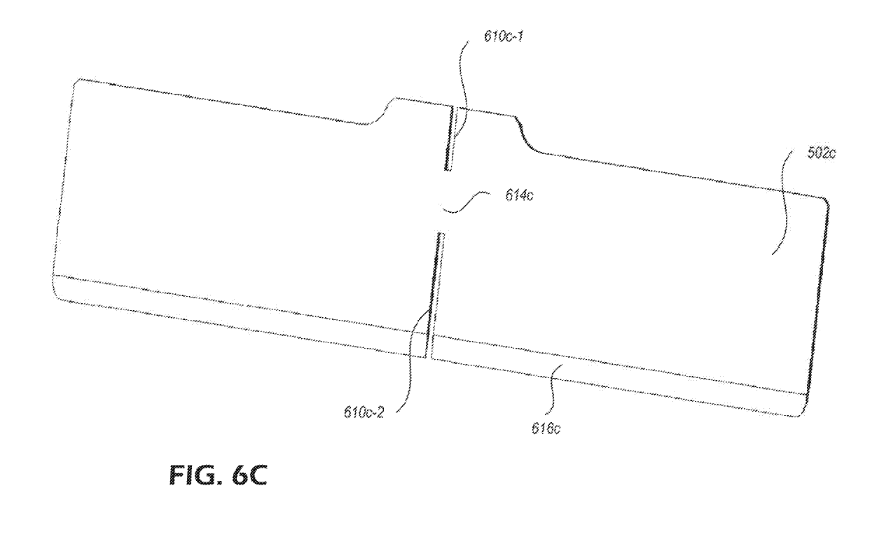

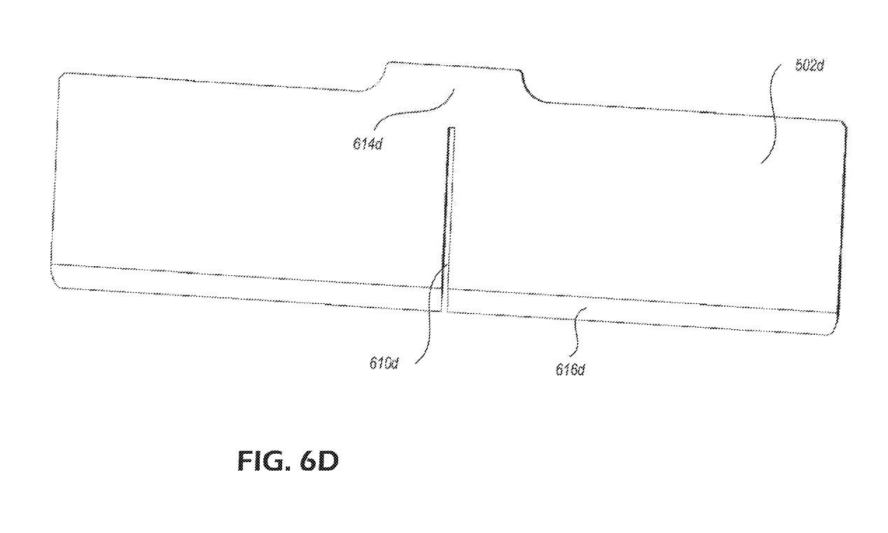

A respective bottom-most edge (e.g., cutting edge) of each of the plurality of blades may reside in a plane that perpendicular to a direction of motion of the blades. For example, as best illustrated in FIGS. 6A-6D, the blades 502 may each include one or more slots sized and dimensioned to receive the other ones of the blades 502. Thus, the blades 502 may be nested in the slots of the other blades, with a respective bottom-most edge of each of the plurality of blades coplanar with one another. Thus, the blades 502 may be inter-locked with one another.

FIGS. 6A-6D show multiple blades 502a, 502b, 502c, 502d (four shown, collectively 502) that may be nestable, according to at least one illustrated embodiment. The blades 502 can be assembled such that each blade passes through the central axis 510 (FIG. 5) with an approximately equal amount of the blade 502 extending radially from either side of the central axis 510. Although four blades 502a, 502b, 502c, and 502d are illustrated, other implementations can include a lesser or a greater number of blades 502. When cutting a food item such a pizza, three or four blades 502 may be employed to result in 6 or 8 triangular slices.

FIG. 6A is a schematic diagram of a first blade 502a that may serve as a bottom blade in a nested set. The first blade 502a includes a slot 610a sized and dimensioned to securely receive additional blades, e.g., second blade 502b, third blade 502c, and fourth blade 502d, in the nestable set. The slot 610a may extend along a height of the first blade 502a. As shown in FIG. 6A, though, the slot 610a may not extend entirely through the height of the first blade 502a. Instead, a solid portion 614a may be positioned between the lower edge of slot 610a and an edge 616a defined by the cutting surface or cutting edge 616a of the first blade 502a. In some implementations, the first blade 502a may include physical registration features 612a that may be used to secure the nestable set of blades 502 to the block 504, for example as discussed below.

FIG. 6B shows a second blade 502b in the nestable set of blades 502. As shown in FIG. 6B, the second blade 502b may include a slot 610b that extends along the height of the second blade 502b. The slot 610b may be split into an upper slot 610b-1 and a lower slot 610b-2 by a solid portion 614b. In some implementations, the length of the lower slot 610b-2 in the second blade 502b may be approximately equal to the length of the solid portion 614a in the first blade 502a. In such an implementation, the second blade 502b may be nested within the first (e.g., bottom) blade 502a such that the lower slot 610b-2 of the second blade 502b encloses the solid portion 614a of the first blade 502a. Accordingly, the bottoms of cutting edges 616a and 616b may be at approximately the same level or planar when the first blade 502a and the second blade 502b are secured by the block 504.

FIG. 6C shows a third blade 502c in a nestable set of blades 502. As shown in FIG. 6C, the third blade 502c may include a slot 610c that extends along the height of the third blade 502c. The slot 610c may be split into an upper slot 610c-1 and a lower slot 610c-2 by a solid portion 614c. In some implementations, the length of the lower slot 610c-2 in the third blade 502c may be approximately equal to the sum of the solid portion 614a in the first (e.g., bottom) blade 502a and the solid portion 614b in the second blade 502b. In such an implementation, the third blade 502c may be nested within the first blade 502a and the second blade 502b such that the lower slot 610c-2 of the third blade 502c encloses the solid portion 614a of the first blade 502a and the solid portion 614b of the second blade 502b. Accordingly, the bottom or cutting edge 616c in third blade 502c may be at approximately the same level as cutting edges 616a and 616b when the first, the second and the third blades 502a-502c, respectively, are secured by the block 504.

FIG. 6D shows a fourth (e.g., upper) blade 502d in the nestable set of blades 502. As shown in FIG. 6D, the fourth blade 502d may include a slot 610d that extends along the height of the fourth blade 502d. As shown in FIG. 6D, though, the slot 610d may not extend entirely through the height of the fourth blade 502d. Instead, a solid portion 614d may be positioned between the upper edge of slot 610d and an upper edge of the fourth blade 502d. In some implementations, the length of the slot 610d in the fourth (e.g., upper) blade 502d may be approximately equal to the sum of the solid portion 614a-614c. In such an implementation, the fourth blade 502d may be nested with the first blade 502a, the second blade 502b, and the third blade 502c such that the slot 610d of the fourth blade 502d encloses the solid portions 614a-614c of the first, the second and the third blades 502a-502c, respectively. Accordingly, the bottom of a cutting edge 616d of the fourth blade 502d may be at approximately the same level as or planar with the cutting edges 616a-616c when the blades 502a-502d are secured by the block 504. Additionally, the cutting edges 616a-616d may be parallel to the faces 212 and 214 of the tray 118 when the block 504 and the nestable set of blades 502a-502d are incorporated into an operable cutting system 100. Further, a plane in which the cutting edges 616a-616d reside may be perpendicular to a direction of travel of the blades 502 as the blades 502 move between the engaged and disengaged positions or configurations. In some implementations, more or fewer than four blades 502 may be used to for a nestable set of blades 502.

While the blades 502 are illustrated and described as extending through the center of the block 504, in some implementations shorter blades may be employed (e.g., each blade essentially cut in half), pairs of blades diametrically opposed to one another across a center point of the block 504. Such would use twice as many blades, and thus may not be preferred.

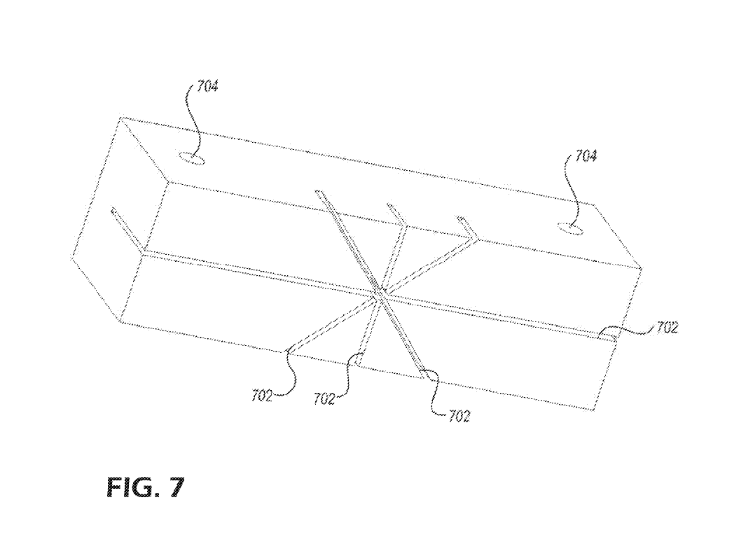

FIG. 7 shows the block 504 of FIG. 5 in more detail. The block 504 may be used to hold the nestable set of blades 502a-502d (FIGS. 5, 6A-6D), according to at least one illustrated embodiment.

The stacking block 504 may include a plurality of channels 702a-702d (four shown, collectively 702). The plurality of channels 702 may be sized and dimensioned to receive portions of respective ones of the nested set of blades 502a-502d (FIGS. 5, 6A-6D). In some implementations, each channel 702a-702d in the plurality will receive one blade 502a-502d from the nested set of blades 502a-502d. As shown in FIG. 7, the block 504 may include four channels 702a-702d. In this implementation, each channel 702a-702d may receive one of the four blades 502a-502d from the nested set of blades 502. In some implementations, the set of channels 702 may be used to position each blade 502a-502d so that each blade 502a-502d is positioned relative to at least one channel 208 (FIG. 2) in tray 118. In some implementations, stacking block 504 may include more or fewer than the four channels shown in FIG. 7.

Block 504 may also include one or more registration features 704 that may be used to secure the nestable set of blades 502 in a desired position or orientation (e.g., pose) with respect to the block 504. The registration features 704 in block 504 may be complementary to the registration features 612a in the bottom blade 502a. The registration features 704 may comprise one or more holes or apertures in stacking block 504. These holes or apertures may be aligned with the registration features 612a in bottom blade 502a, which may comprise a hole or aperture. One or more fasteners 506 may be used to secure the nestable set of blades 502a-d to the block 504. As shown in FIG. 5, fasteners 506 may include one or more clips, posts or pegs that may removably secure the bottom blade 502a with the block 504 when the fastener 506 is inserted through the registration features 704 and 612a. Because each of the remaining blades 502b-502d are nested with the first or bottom blade 502a, the remaining blades 502b-502d may likewise be secured to stacking block 504 without using any additional fasteners 506 (e.g., clips, pegs, bolts and nuts, screws, cam fasteners). The nesting of blades 502a-502d using two fasteners 506 may allow for a food preparation worker to quickly and easily remove all of the blades 502a-502d from the cutting system 100, e.g., when cleaning the blades 502a-502d or when changing out one or more of the blades 502a-502d for a new blade 502 or for sharpening or other maintenance.

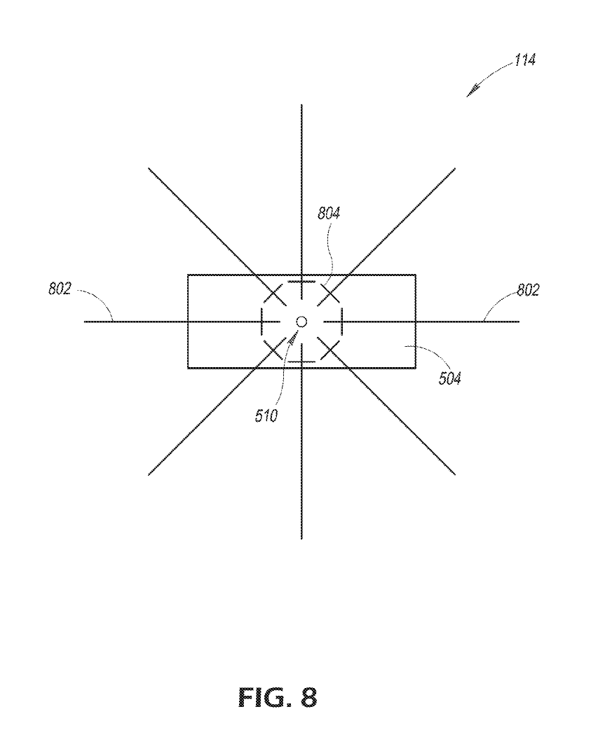

FIG. 8 shows a bottom view of the cutting assembly 114 in which the blades 802 are positioned to extend radially away from a central axis without passing through the central axis, according to at least one illustrated embodiment. In some implementations, each blade 802 may be diametrically opposed to another blade 802 across the central axis. In some implementations, an odd number of blades 802 may be used in the cutting assembly 114 such that one or more of the blades 802 may not be diametrically opposed to another blade 802. Each blade 802 may be secured or attached to the block 504 by one or more registration features 804. For example, the registration feature 804 may be a latch located on a face of the block 504 that may be used to secure the blade 802 to the block 504. Other registration features may be used to secure or attach the blades 802 to the block 504. For example, the registration feature 804 may include a notch or a spring-loaded lever or clamp located internal to the block 504 that engages the blade 802 when the blade 802 is inserted into the block 504. Accordingly, an approximately equal amount of each blade 802 may extend radially from the central axis 510 without passing through the central axis. In this implementation, a cutting assembly with a number N of blades 802 will cut the food item into N pieces.

FIG. 9 shows a cutting assembly 114 in which the blades 502 are parallel. In this implementation, the blades 502 may cut the food into parallel strips. Accordingly, a cutting system 100 that uses N parallel blades 502 may cut food into N+1 pieces. As shown in FIG. 9, for example, a cutting assembly 114 may have a block 902 in which parallel channels 904 may be sized and dimensioned to receive the blades 502, and to position the blades at some distance apart from each other that may correspond to the size of a piece of food to be processed. The tray 118 (not shown in FIG. 9) used to hold the food item may have corresponding channels positioned to meet the parallel blades 502. Block 902 may have one or more registration features 906 that secure or attach each of the parallel blades to the block 502. For example, the registration features 906 may include one or more pins that extend through the block 902 in a direction that is perpendicular to each of the faces 512 and 514 of the blades 502. In some implementations, the registration features may include one or more latches located on one of the faces of the block 902 that secures a blade 502 to the block 902. The registration features may include notches, latches, or levers located at least partially inside of a channel 904 that secure a blade 502 to the block 902 when the blade 502 is inserted into the channel 904. In some implementations in which blades 502 are arranged to cut foods using parallel blades, the transmission 112 and the frame 110 may remain substantially unchanged from implementations in which the cutting system 100 cuts foods having a round shape.

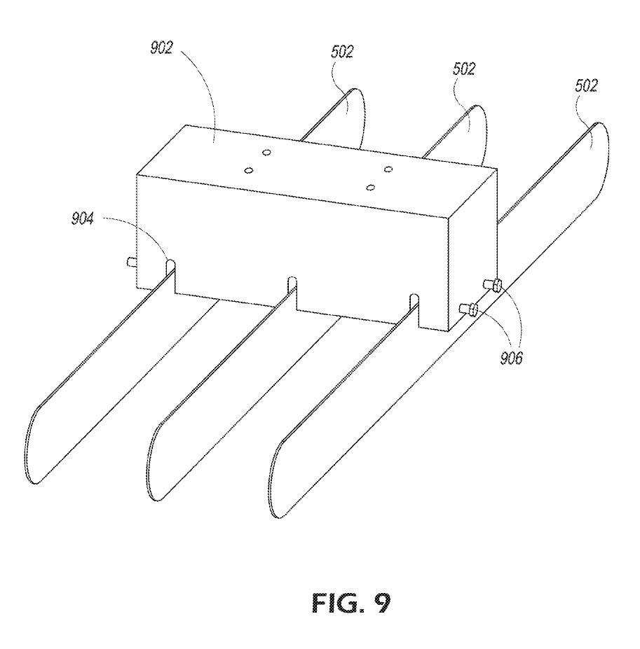

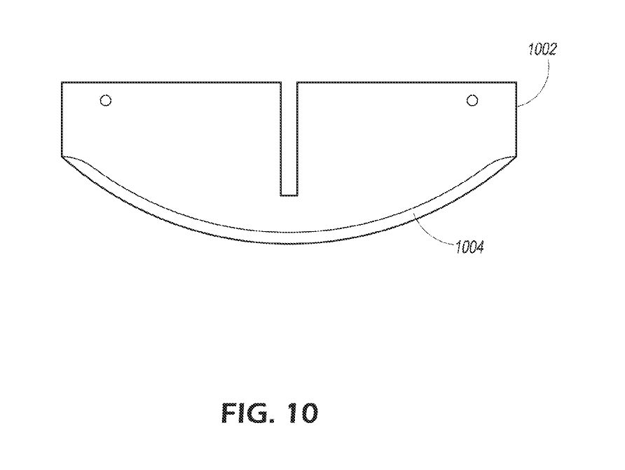

FIG. 10 shows a blade 1002 that has a curved shape or pattern. As shown in FIG. 10, the blades 1002 may form an arc that extends outward from the block 504. In this implementation, the cutting edges 1004, located on the edges of the blades 1002 opposite the block 504, may form the contours of a concave surface (e.g., a bowl) when multiple blades 502 are secured to the block 504. In this implementation, the channels 208 in the tray 118 (not shown in FIG. 12) may be sized and dimensioned to accommodate the arc formed by the blades 1002. For example, the channels 208 may be dimensioned to slope downward from the raised peripheral rim 204 towards the central well 228 such that the increased height at the center of the blades 1002 will not cut into channels 208 when the cutting assembly 114 is in the extended or engaged position.

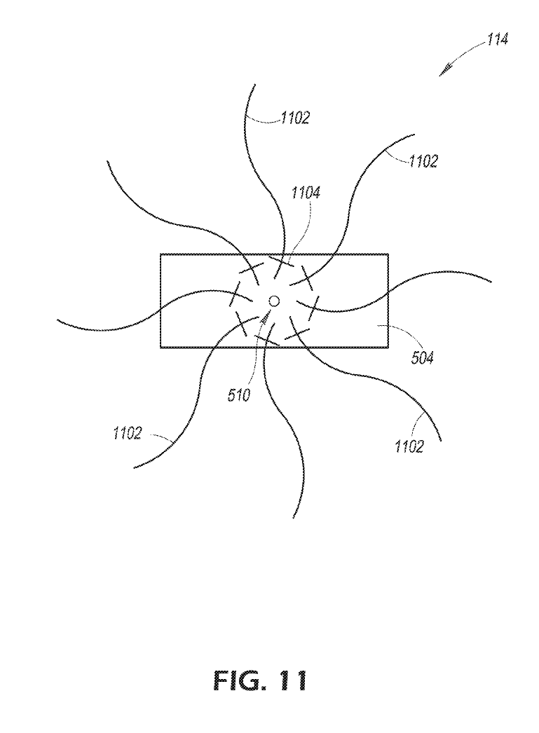

FIG. 11 shows a bottom view of a cutting assembly in which the edges of the blades curve within a plane formed by the edges of the blades, according to at least one illustrated embodiment. As shown in FIG. 11, the blades 1102 may radiate outward from the central axis 510, and are curved about the central axis 510. In this implementation, the cutting edges, located on the edges of the blades 1102 opposite the block 504, may be at substantially level or within the same plane. In the cutting edges of the blades 1102 may be parallel to the faces 212 and 214 of the tray 118 when the blades are secured or attached to the block 504. In some implementations, the channels 208 in the tray 118 (not shown in FIG. 11) may be sized and dimensioned to accommodate the curves formed by the blades 1102 when the cutting assembly 114 is in the extended or engaged position. Each blade 1102 may be secured or attached to the block 504 by one or more registration features 1104. For example, the registration feature 1104 may be a latch located on a face of the block 504 that may be used to secure the blade 1102 to the block 504. Other registration features may be used to secure or attach the blades 1102 to the block 504. For example, the registration feature 1104 may include a notch or a spring-loaded lever or clamp located internal to the block 504 that engages the blade 1102 when the blade 1102 is inserted into the block 504.

FIG. 12 shows a cutting system 100 in which the blades 1202 have a curved shape or pattern, according to at least one illustrated embodiment. In this implementation, the blades may be formed into non-linear shapes (e.g., figures, letters, logos, or geometric designs) into which the food item may be cut. Accordingly, the blade edges may form a plane that is approximately parallel to the base 120. In this implementation, the channels 1204 in the block 1206 may be sized and dimensioned to accept each of the blades 1202. The block 1206 may have one or more registration features 1208 to secure or attach each of the blades 1202 to the block 1206. For example, the registration features 1208 may include one or more pins that extend through one or more of the blades 1202. In some implementations, the registration features 1208 may include one or more latches located on one of the faces of the block 1206 that secures a blade 1202 to the block 1206. The registration features 1208 may include notches, latches, or levers located at least partially inside of a channel 1204 that secure a blade 1202 to the block 1206 when the blade 1202 is inserted into the channel 1204.

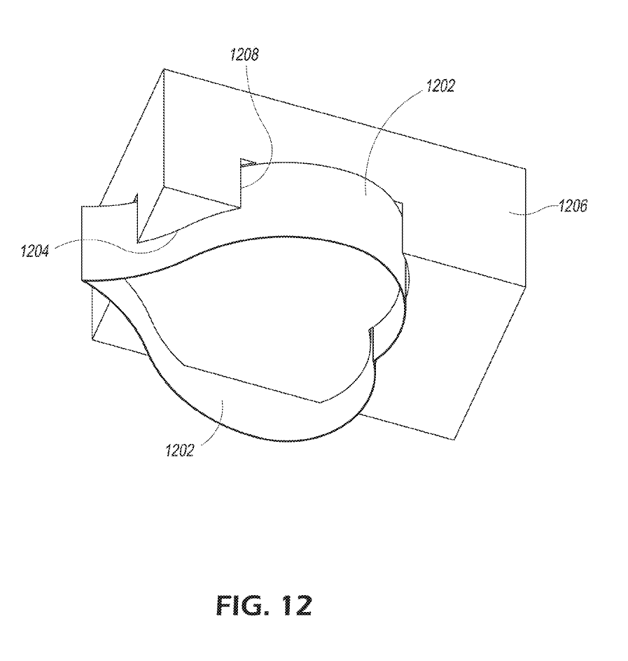

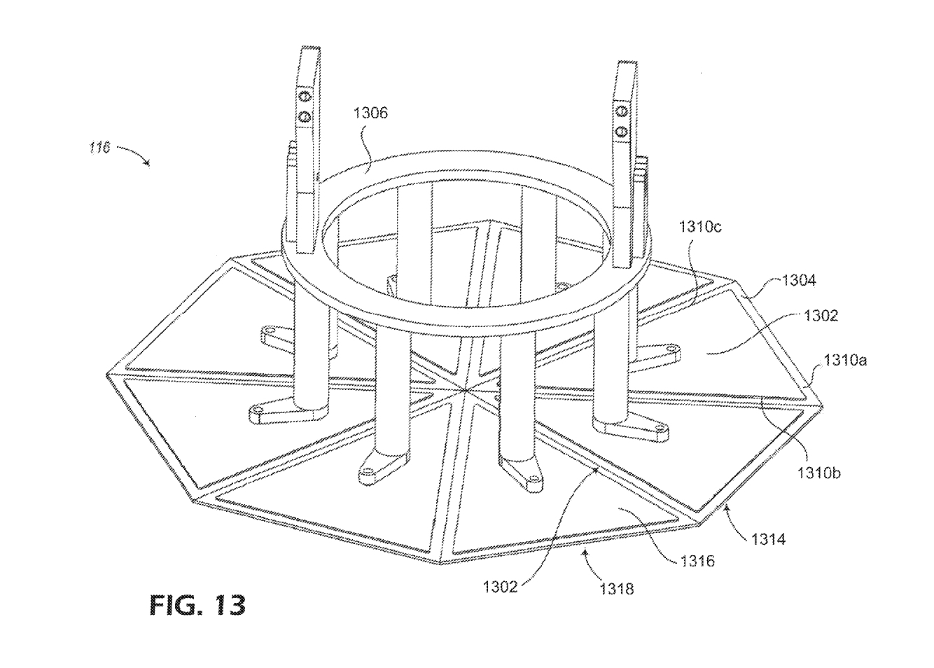

FIG. 13 shows the cleaning assembly 116 of FIG. 1 in more detail. The cleaning assembly 116 may include a plurality of support plates 1302a, 1302b, 1302c (eight shown, only three called out, collectively 1302), a plurality of wipers 1304a, 1304b, 1304c (eight shown, only three called out, collectively 1304), and bracket 1306.

Each support plate 1302 may have a shape that is related to the shape into which the food item is to be cut. As shown in FIG. 13, for example, the support plates 1302 may have a triangular profile with dimensions defined by sides 1310a, 1310b, 1310c where the size of the triangular profile may be related, for example, to a size of a piece of pizza to be cut by cutting system 100. Each support plate 1302 may have an upper face 1312 and a lower face 1314 arranged opposite to each other and separated by a thickness of the support plate 1302. In use, the upper and lower faces 1312 and 1314 may be parallel to the tray 118, and the upper and lower faces 1312 and 1314 may be perpendicular to the faces 512 and 514 of the blades 502 (FIG. 5).

The wipers 1304 may have the same profile as the profile of the support plates 1302, but with slightly larger dimensions. Thus, as shown in FIG. 13, each wiper 1304 may be attached to a respective one of the support plates 1302 and extend beyond the perimeter of one of the respective support plate 1302. In some implementations, the wipers 1304 may be selectively detachable from the respective support plate 1302 to facilitate cleaning and/or replacement. Each wiper 1304 may have a first face 1316 and an opposing second face 1318; the two faces 1316 and 1318 (only one of each called out) may be separated by a thickness of the wiper 1304. The faces 1316 and 1318 of the wipers 1304 may be perpendicular to the faces 512 and 514 of blades 502 (FIG. 5).

As shown in FIG. 13, the adjacent support plates 1302 may be arrayed to form gaps 1320a, 1320b, 1320c (eight shown, only three called out, collectively 1320). The support plates 1302 may be positioned such that the gaps 1320 have a size slightly larger than a widest width of the blades 502. In some implementations, the gaps 1320 are formed between the portions of respective pairs of wipers 1304, which portions extend from beyond the perimeters of successively adjacent support plates 1302 to form two opposing wipers 1304. The gaps 1320 are sized and dimensioned to closely receive the width of the respective cutting blade 502 such that the opposing wipers 1304 physically engage the faces 512 and 514 of the respective cutting blade 502. Accordingly, as the cutting blade 502 moves from the engaged or extended position, in which it engages the food item and tray 118, to the disengaged or retracted position, the wipers 1304 swipe the faces 512 and 514 of the blades 502 of any food items (e.g., melted cheese, toppings, crumbs) that may have become attached to the blades 502. In some implementations, the wipers 1304 may be made of a food-grade polymer or silicone.)

The optional bracket 1306 allows the cleaning assembly 116 to be attached to the frame 110 and secure each of the support plates 1302. The bracket 1306 may secure or fasten to each of the support plates 1302, thereby allowing the wipers 1304 to clean the entire length of the blades 502. In some implementations, the bracket 1306 may have a height that is greater than the height of the blades 502. Such an implementation may allow the upper assembly 104 to completely retract the blades 502 through the wipers 1304 such that the lower edge of the blades 502 are at a position above the wipers 1304. Such a configuration may allow for cleaning over the entirety of the faces 512 and 514 of each blade 502.

In implementations in which the blades 502 are curved or formed into other non-linear shapes or patterns, the support plate 1302 and corresponding wipers 1304 may have matching shapes.

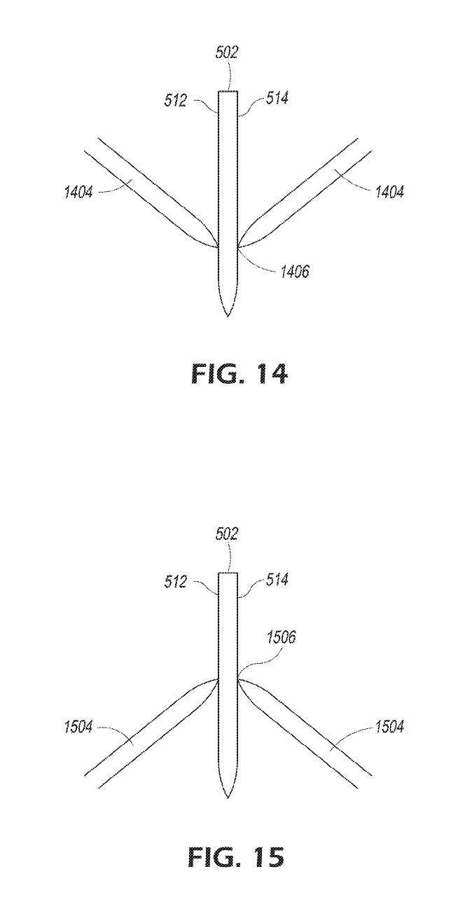

FIG. 14 shows a cross sectional view of a pair of opposing wipers engaging a blade 502 at a downward angle. In this implementation, the wipers 1404 may be angled in a downward direction where the edge of the wipers 1404 adjacent the support plates 1302 is relatively higher or lower than the edge of the wipers 1404 opposite of the support plate 1302. In this example, opposing wipers 1404 may meet to form a “V” shape with a gap 1406 at the point formed by the two sides of the “V” shape. The gap 1406 is sized and dimensioned to closely receive the width of the respective cutting blade 502 such that the opposing wipers 1404 physically engage the faces 512 and 514 of the respective cutting blade 502. Accordingly, as the cutting blade 502 moves from the engaged or extended position, in which it engages the food item and tray 118, to the disengaged or retracted position, the wipers 1404 swipe the faces 512 and 514 of the blades 502 of any food items (e.g., melted cheese, toppings, crumbs) that may have become attached to the blades 502.

FIG. 15 shows a cross sectional view of a pair of opposing wipers engaging a blade 502 at an upward angle. In this implementation, opposing wipers 1504 may meet to form an upside-down “V” with the gap 1506 at the point formed by the upside-down “V” shape. The gap 1506 is sized and dimensioned to closely receive the width of the respective cutting blade 502 such that the opposing wipers 1504 physically engage the faces 512 and 514 of the respective cutting blade 502. Accordingly, as the cutting blade 502 moves from the engaged or extended position, in which it engages the food item and tray 118, to the disengaged or retracted position, the wipers 1504 swipe the faces 512 and 514 of the blades 502 of any food items (e.g., melted cheese, toppings, crumbs) that may have become attached to the blades 502.

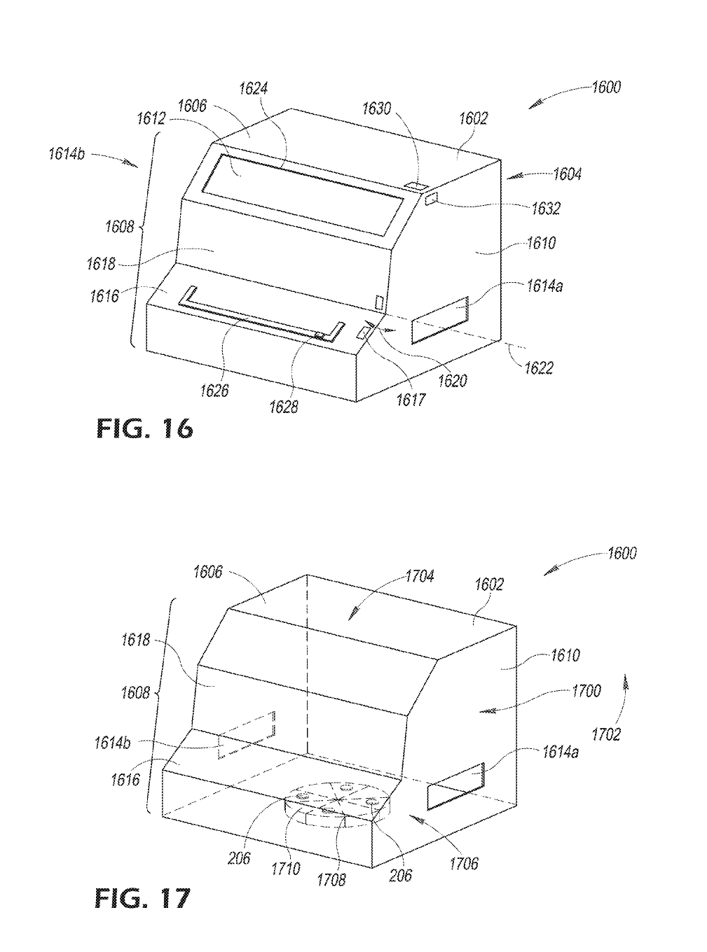

FIG. 16 shows a cover 1600 that may be placed over at least a portion of the cutting system 100. The cover 1600 may include a guard-shell 1602 that has a back wall 1604, a top wall 1606, a front wall 1608, one or more sidewalls 1610, and optionally a bottom wall (not shown). In some implementations, one or more of the top wall 1606 and/or the sidewall(s) 1610 may include a window 1612, such as a window comprised of acrylic, plastic, or like suitable materials, that enables an operator to safely view the cutting system 100. The window 1612 may facilitate the positioning of the pizza or other food item under the cutting assembly 114 in the cutting system 100. The sidewalls 1610 may include opposing apertures 1614a, 1614b that may be aligned with the cutting assembly 114 enclosed within the cover 1600 to provide an ingress and/or egress for food items.

In some implementations, the front wall 1608 may include a movable portion 1616 and a stationary portion 1618. The movable portion 1616 may be rotatably coupled to the stationary portion 1618 of the front wall 1608, and may rotate or pivot 1620 along an axis of rotation 1622 that runs transversely across the front wall 1608. In some implementations, a sensor 1617 may be located along or adjacent to a path that the movable portion 1616 travels when the movable portion 1616 rotates around the axis of rotation 1622. Such a sensor 1617 may, for example, be a proximity sensor, an RFID tag, a Hall Effect sensor, or any other type of sensor that may generate a signal when the movable portion 1616 of the front wall 1608 moves towards or engages the sensor 1617. The sensor 1617 may communicatively couple with the actuator 404, and may thereby transmit such a signal to engage the actuator 404. As such, the movable portion 1616 may activate or engage the sensor 1617 when the movable portion 1616 rotates downward, resulting in the sensor 1617 generating a signal that is transmitted to the actuator 404. When received by the actuator 404, such a signal may thereby trigger the actuator 404, which may act to move the cutting assembly 114 downward to cut the food item (e.g., the sauced, cheesed, topped flatten and partially cooked dough). In some implementations, such a sensor 1617 may be physically attached to the cover 1600. Such operation may provide a safety feature for the cutting system 100.

In some implementations, the movable portion 1616 of the front wall 1608 may include a handle 1626 that is physically secured to the movable portion 1616 of the front wall 1608. As such, the handle 1626 may be oriented and placed to facilitate the rotation 1620 of the movable portion 1616 of the front wall 1608. In some implementations, the handle 1626 may include a user-engageable switch 1628, or other similar component, that has an ON state and an OFF state. The user-engageable switch 1628 may communicatively couple with the actuator 404, and be operable to transmit a signal to the actuator 404, for example, when the user-engageable switch 1628 is in the ON state. In some implementations, the actuator 404 may need to receive such a signal from the user-engageable switch 1628 and a signal from the sensor 1617 before the actuator 404 can be engaged to thereby activate the transmission 112 to move the cutting assembly 114. Such a user-engageable switch 1628 may provide a further safety mechanism for the operation of the cutting system 100.

In some implementations, the cover 1600 may include an override switch 1630 that may have an ON position and an OFF position. When in the ON position, the override switch 1630 may prevent the cutting assembly 114 from being activated and moving out of the retracted position, even when the moveable portion is in or moved to a closed configuration or position from an opened configuration or position. For example, the override switch 1630 may interrupt the signal(s) from being communicated from the sensor 1617 and/or the user-engageable switch 1628 to the actuator 404. In some implementations, for example, the override switch 1630 may activate a solenoid 1632 that may be used to selectively couple or de-couple the sensor 1617 and the actuator 404.

In some implementations, the cover 1600 may be surrounded by a “light curtain,” comprised of one or more light generating components that generate electromagnetic waves and associated sensors oriented to receive the electromagnetic waves generated by the light generating components. As such, the cutting assembly 114 may operate automatically in a pass-through mode in which no operator interaction is needed for the cutting assembly 114 to process or cut food items. In such an implementation, the cutting assembly 114 may continue to operate in a pass-through mode unless one or more of the sensors stops receiving the corresponding electromagnetic wave from the light generating component, such as may occur, for example, when a human reaches through the “light curtain” and blocks one or more optical paths between a light generating component and associated sensor. When such a situation occurs, the cutting assembly 114 may automatically stop operating until, for example, the cutting assembly 114 is reset, such as may occur by activating by one or more user engagable input components 124.

The front wall 1608 may include a removable portion 1624 that may be selectively removed from the cover 1600. In some implementations, for example, the removable portion 1624 may provide access to the interior of the cover and be aligned with the cutting assembly 114 on the cutting system 100. As such, the removable portion 1624 may be used to access the cutting assembly 114 and thereby, for example, change and/or clean the blades 502.

FIG. 17 shows an interior portion 1700 of the cover 1600. One or more of the back wall 1604, the top wall 1606, the front wall 1608, and the one or more sidewalls 1610 may separate an interior portion 1700 of the cover 1600 from an exterior portion 1702. As such, the interior portion 1700 may include a top region 1704 and a bottom region 1706. In such an implementation, the cutting assembly 114 of the cutting system 100 may be located relatively towards the top region 1704 of the interior portion 1700 of the cover 1600 when the cutting assembly 114 is in the retracted position. When the transmission 112 is engaged, the transmission 112 may translate the cutting assembly 114 into the cutting position in the bottom region 1706 of the cover 1600 (such as, for example, to cut a food item).

The cover 1600 may surround a platform 1708 that may be positioned within the bottom region 1706 of the interior portion 1700 of the cover 1600. The platform 1708 may include, for example, one or more of the base 120 and/or the square base 350. The platform 1708 may be aligned with one or more apertures 1614a, 1614b. The apertures 1614a, 1614b may be used as an ingress and/or egress for food items into the interior portion 1700 of the cover 1600. The platform 1708 may include an upward-facing surface 1710 that may include one or more registration features 206, such as, for example, one or more depressions in the upward-facing surface 1710 of the platform 1708. Such registrations features 206 may be used to align a tray 118 onto the platform 1708. In some implementations, the platform 1708 may be selectively removed from the cover 1600. As such, another type of platform 1708, such as one that might be used to cut a different type or size of food item, may be optionally placed within the interior portion 1700 of the cover 1600.

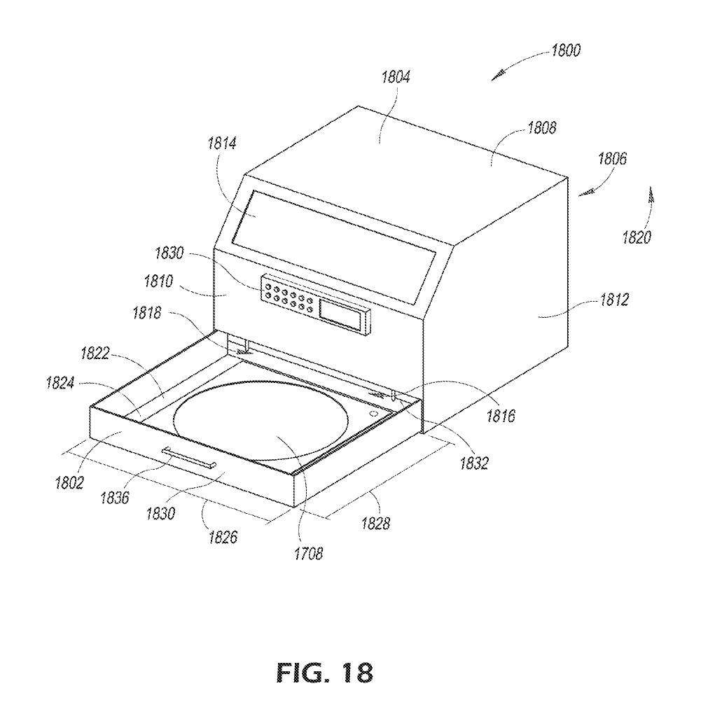

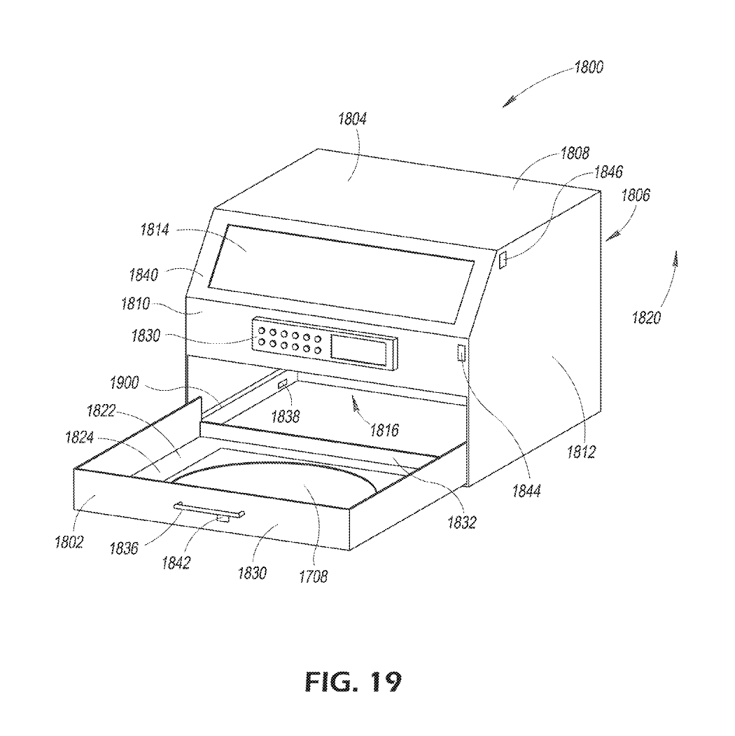

FIG. 18 shows a cover 1800 having a drawer 1802 that moves between an open position and a closed position with respect to the remaining portion of the cover 1800. FIG. 19 shows the cover 1800 with a portion of a front wall 1810 removed. The cover 1800 includes a guard-shell 1804 that has a back wall 1806, a top wall 1808, the front wall 1810, and one or more sidewalls 1812. The guard-shell 1804 may separate an interior portion 1818 of the cover 1800 from an exterior 1820 of the cover 1800. In some implementations, one or more of the top wall 1808 and/or the sidewall(s) 1812 may include a window 1814, such as a window comprised of acrylic, plastic, or like suitable materials, that enables an operator to safely view the cutting system 100. The window 1814 may facilitate the positioning of the pizza or other food item by the operator under the cutting assembly 114 in the cutting system 100. The front walls 1810 may include an aperture 1816 that may provide space for the drawer 1802 to translate from an open position to a closed position as discussed below.

The drawer 1802 may include a bottom 1822 that has an upward facing surface 1824. In some implementations, the bottom 1822 of the drawer 1802 may extend substantially across a width 1826 and a depth 1828 of the drawer 1802. The upward facing surface 1824 may be used to support the platform 1708. As discussed below, the upward facing surface 1824 may include one or more registration features that enable the platform 1708 to be selectively removed and replaced with another type of platform 1708, such as a platform 1708 that may be used for a different type of food. The drawer 1802 may include a front wall 1830 and an opposing back wall 1832, separated by the depth 1828 of the drawer 1802. In some implementations, the front wall 1830 may include a handle 1836 to facilitate the opening and the closing of the drawer 1802.

The drawer 1802 may be supported by one or more sets of extendable arms 1900 (FIG. 19) that may include tracks and/or rollers that guide the drawer 1802 in translating from an open position to a closed position. In the open position, at least a portion of the drawer 1802 may be positioned in the exterior 1820 relative to the cover 1800. In such a position, food items may be loaded onto the platform 1708 for processing by the cutting system 100, and/or retrieved from the platform 1708 after such processing by the cutting system 100 is complete. In the closed position, the drawer 1802 may be completely surrounded by the guard-shell 1804 and contained within the interior portion 1818 of the cover. As such, the front wall 1830 of the drawer may be flush with the front wall 1810 of the cover 1800. In such an implementation, the platform 1708 may be aligned with and positioned beneath the cutting assembly 114 when the drawer 1802 is in the closed position.

The drawer 1802 may have an open position, a closed position, and a cutting position. In such an implementation, the open position may correspond to a position in which at least a portion of the drawer 1802 is positioned in the exterior 1820 relative to the cover 1800. The closed position may correspond to a position in which the drawer 1802 has been moved towards and into the interior portion 1818 of the cover 1800 such that the front wall 1830 of the drawer 1802 is flush with the front wall 1810 of the cover 1800. The cutting position may correspond to a position in which the drawer 1802 has been pushed further into the interior portion 1818 of the cover 1800 past the closed position. As such, the front wall 1830 of the drawer 1802 may be recessed in relation to the front wall 1810 of the cover 1800 when the drawer 1802 is in the cutting position. In some implementations, the drawer 1802 may need to be moved or pushed further into the interior portion 1818 of the cover 1800 to reach the cutting position to trigger the actuator 404.

The drawer 1802 may trigger a sensor 1838 when the drawer 1802 has moved into the interior portion 1818 of the cover 1800, such as, for example, when the drawer 1802 is in the closed position and/or the cutting position. Such a sensor 1838 may be, for example, a proximity sensor, a switch, a Hall effect sensor, or any other similar type of sensor that may detect the presence of and/or be engaged by the drawer 1802 when the drawer 1802 has moved into the interior portion 1818 of the cover 1800. Such a sensor 1838 may be communicatively coupled to the actuator 404. In such an implementation, when the sensor 1838 is activated, the sensor 1838 may generate a signal and transmit such generated signal to the actuator 404, to thereby trigger the actuator 404. Once triggered, the actuator 404 may cause the cutting assembly 114 to move downward to cut the food item (e.g., the sauced, cheesed, topped flatten and partially cooked dough).

In some implementations, the cover 1800 may include a user-engageable switch 1842, or other similar component, that has an ON state and an OFF state. The user-engageable switch 1842 may communicatively couple with the actuator 404, and be operable to transmit a signal to the actuator 404 when the user-engageable switch 1842 is in the ON position. In some implementations, the actuator 404 may need to receive such a signal from the user-engageable switch 1842 and a signal from the sensor 1838 before the actuator 404 can be engaged to move the cutting assembly 114 to the cutting position. In some implementations, the user-engageable switch may be located on or proximate the handle 1836. Such a user-engageable switch 1842 may provide a further safety mechanism for the operation of the cutting system 100.

In some implementations, the cover 1800 may include an override switch 1844 that may have an ON position and an OFF position. When in the ON position, the override switch 1844 may prevent the cutting assembly 114 from being activated and moving out of the retracted position. For example, the override switch 1844 may interrupt the signal from being communicated from the sensor 11838 to the actuator 404. In some implementations, for example, the override switch 1844 may activate a solenoid 1846 that may be used to selectively couple or de-couple the sensor 1838 and the actuator 404, and/or to selectively couple or de-couple the user-engageable switch and the actuator 404.

The front wall 1810 may include a removable portion 1840 that may be selectively removed from the cover 1800. In some implementations, for example, the removable portion 1840 may provide access to the interior portion 1818 of the cover 1800 and be aligned with the cutting assembly 114 on the cutting system 100. As such, the removable portion 1840 may be used to access the cutting assembly 114 and thereby, for example, change and/or clean the blades 502.

In some implementations, the cover 1800 may include a display 1834 that may provide visual, audible, or other types of indications regarding information related to the cutting system 100. Such information may include, for example, the number of operations that the cutting assembly 114 has performed since the last maintenance or cleaning, the pressure and/or force provided by the transmission 112 to move the cutting assembly 114 to the cutting position, and/or the time that has elapsed since the cutting assembly 114 was last cleaned, and any other similar type of information.

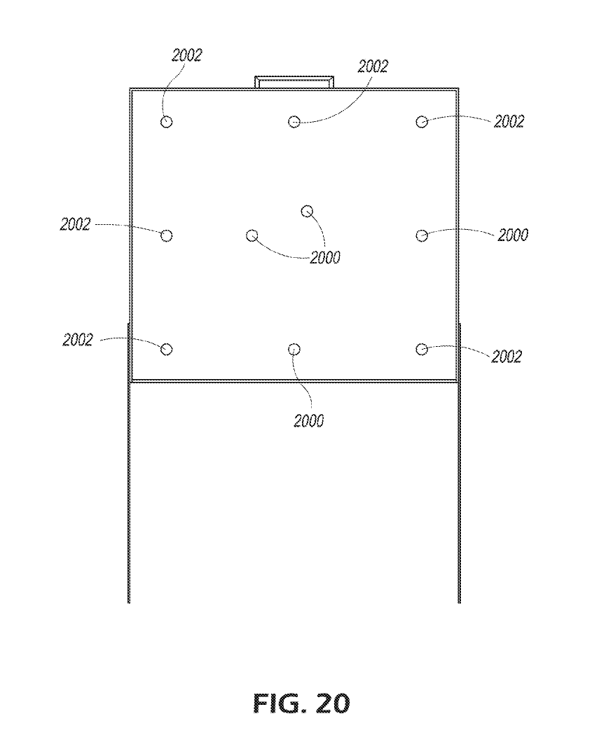

FIG. 20 shows the upward-facing surface 1824 of the drawer 1802 in which the upward-facing surface 1824 has a plurality of registration features 2000 and physical coupling components 2002, according to at least one illustrated implementation. The registration features 2000 may selectively engage with corresponding registration features 2000 located on the platforms 1708. In some implementations, the registration feature 2000 on the upward-facing surface 1824 of the drawer 1802 may include posts or other extensions that project upwards from the upward-facing surface 1824 and engage with corresponding recesses on the platforms 1708. In some implementations, the registration feature 2000 on the upward-facing surface 1824 of the drawer 1802 may include recesses or other depressions that are recessed into the upward-facing surface 1824 and engage with corresponding posts or extensions on the platforms 1708. The registration features 2000 on the upward-facing surface 1824 may be spaced to engage the corresponding registration features on the platform 1708, and to thereby position the platform 1708 upon the drawer 1802 such that the platform 1708 will be aligned with the cutting assembly 114 when the drawer 1802 is in the closed position and/or cutting position.

The physical coupling components 2002 may be used to physically couple and secure the platform 1708 to the upward-facing surface 1824 of the drawer 1802. In some implementations, for example, the physical coupling components 2002 may include one or more threaded receptacles that may be configured to securely receive a screw or bolt that is placed through an aperture on the platform 1708. In some implementations, the physical coupling components 2002 may include one or more tabs or snaps that may be selectively engaged with corresponding apertures or snaps on the platform 1708. Such physical coupling components 2002 on the upward-facing surface 1824 of the drawer 1802 may be selectively and quickly de-coupled from the corresponding components on the platform 1708 to enable the platforms to be quickly and efficiently changed.

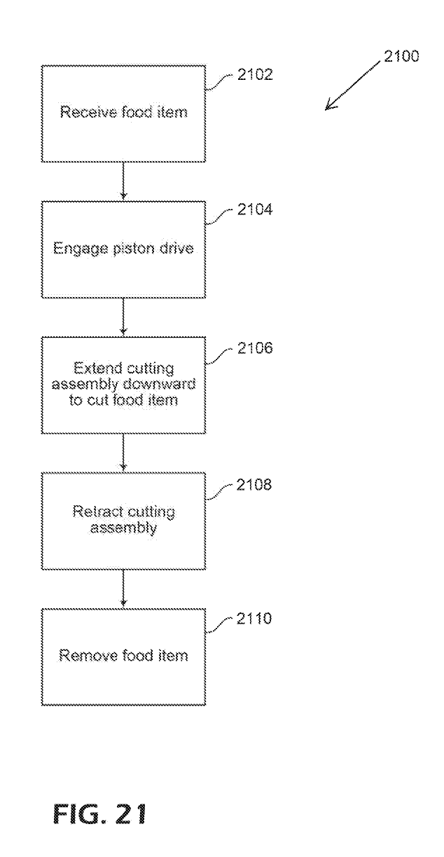

FIG. 21 is a flowchart that shows a method 2100 of operating the cutting system 100, according to at least one illustrated embodiment.

At 2102, the cutting system 100 receives a food item to be cut. The food item may be positioned on a tray 118, which in turn is positioned on the base 120 so that the food item is located in a desirable or appropriate location for cutting assembly 114. In some implementations, various registration features of the tray 118 and/or base 120 (e.g., the raised peripheral rim 204 of tray 118) may be used to position the food item. The cutting system may manually receive the item from a food preparation work or from an automated or mechanical system, for example a robot.

At 2104, the cutting system 100 receives a signal to engage an actuator 404. Such a signal may be received when a food preparation worker engages a start button or switch, such as, for example, user-engageable switches 1628, 1842. In some implementations, the actuator 404 may be responsive to a signal indicative of an appearance or presence of a food item properly placed on the tray 118 or base 120. This signal may be produced by one or more sensors (e.g., light emitter/receiver pair, pressure sensor, contact sensor) used to identify the presence and location of food items on the tray 118 and/or base 120. In some implementations, the signal may be produced by one or more sensors 1838 that identify the presence and/or location of the platform 1708 as being aligned with the cutting assembly 114. Alternatively, the signal may be produced manually, for instance by operation of a switch or key. In some implementations, the actuator 404 may need to receive one or more of such signals to be activated. In some implementations, an override switch, such as the override switches 1630, 1844, may interrupt the signal from being received by the actuator 144 at 2104, thereby preventing the actuator 404 from being activated.

At 2106, the cutting system 100 engages the actuator (e.g., piston, electric motor, solenoid) 404 to drive the rod or shaft 402 and the attached cutting assembly 114 in a downward direction. In yet other implementations, the cutting system 100 may be manually operated via a human operating a lever or other member to move the cutting assembly 114 between the extended and retracted positions.

At 2108, the blades 502 in cutting assembly 114 move downward to engage the corresponding channels 208 in the tray 118 or base 120. In some implementations, the transmission 112 may drive the plurality of blades 502 in cutting assembly 114 as a single assembly, e.g., such as when the blades are nested in the block 504, along the central axis 510. The cutting system 100 may continue to move the blades 502 downward until a condition is met. For example, the cutting system 100 may continue to extend the blades 502 downward until the actuator 404 has exceeded a defined threshold force. In some implementations, the actuator 404 may operate for a defined period of time to provide a downward force. That defined period of time may set to be sufficiently long to ensure that the blades 502 have fully engaged the corresponding channels 208 in the tray 118. In some implementations, the actuator 404 may continue to move the blades 502 until a signal is received that indicates that the blades 502 have made contact with the channels 208 in tray 118 or base 120, or that a portion of the cutting assembly 114 has traveled a defined distance.

At 2110, the actuator 404 may reverse the direction of travel of the blades 502, withdrawing the blades 502 in an upward direction towards the retracted or disengaged position. During this movement, the wipers 1304 may wipe, or “squeegee,” the faces 512 and 514 of blades 502 to remove food items stuck to the faces 512 and 514, thereby cleaning the blades 502.

At 2112, the cut food item is removed from the cutting system 100. In some implementations, a food preparation worker may remove the food item, for example along with the tray 118. In some implementations, the food item may be removed by an automated or mechanical system, for example a robot. A cover (not shown) may be placed on the tray 118 to form packaging that encloses the cut food item. The packaging along with the food item may, for example, be loaded into an oven for transport to a delivery destination. The food item may be cooked while being transported to the delivery destination, for example with one or more cooking parameters (e.g., temperature, time, humidity) controlled based on an estimated time to destination.

The cutting system 100 resets to receive and cut another food item.

The above description of illustrated embodiments and implementation, including what is described in the Abstract, is not intended to be exhaustive or to limit the embodiments or implementations to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to cutting various types of food items, not necessarily the exemplary cutting of pizza generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Pat. No. 9,292,889, issued Mar. 22, 2016, entitled “SYSTEMS AND METHODS OF PREPARING FOOD PRODUCTS”; U.S. patent application Ser. No. 15/040,866, filed Feb. 10, 2016, entitled “SYSTEMS AND METHODS OF PREPARING FOOD PRODUCTS”; U.S. Provisional Patent Application No. 62/311,787, filed Mar. 22, 2016, entitled “CONTAINER FOR TRANSPORT AND STORAGE OF FOOD PRODUCTS”; U.S. Provisional Patent Application No. 62/320,282, filed Apr. 8, 2016, entitled “ON-DEMAND ROBOTIC FOOD ASSEMBLY AND RELATED SYSTEMS, DEVICES AND METHODS”; U.S. Design Patent application No. 29/558874, filed Mar. 22, 2016, entitled “FOOD CONTAINER”; U.S. Design Patent application No. 29/558873, filed Mar. 22, 2016, entitled “FOOD CONTAINER COVER”; U.S. Design Patent application No. 29/558872, filed Mar. 22, 2016, entitled “FOOD CONTAINER BASE”; U.S. Design Patent application No. 29/574802, filed Aug. 18, 2016, entitled “FOOD CONTAINER”; U.S. Design Patent application No. 29/574805, filed Aug. 18, 2016, entitled “FOOD CONTAINER COVER”; U.S. Design Patent application No. 29/574808, filed Aug. 18, 2016, entitled “FOOD CONTAINER BASE”; Hong Kong Patent Application No. 16103287.8, filed Mar. 21, 2016, entitled “SYSTEMS AND METHODS FOR PREPARING FOOD PRODUCTS”; European Patent Application No. EP14814044.5, filed Nov. 9, 2015, entitled “SYSTEMS AND METHODS FOR PREPARING FOOD PRODUCTS”; PCT Application No. PCT/US2014/042879, filed Jun. 18, 2014, entitled “SYSTEMS AND METHODS FOR PREPARING FOOD PRODUCTS”; U.S. Provisional Patent Application No. 62/394,063, filed Sep. 13, 2016, entitled “CUTTER WITH RADIALLY DISPOSED BLADES”; and U.S. Provisional Patent Application No. 62/532,914, filed Jul. 14, 2017, entitled “SYSTEMS AND METHOD RELATED TO A FOOD-ITEM CUTTER AND ASSOCIATED COVER”; are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus, comprising:
a plurality of blades, each of the blades having a pair of faces opposed to one another across a thickness of the blade, and each of the blades having a cutting edge;
a transmission operable to move the plurality of blades between a retracted position and an extended position; and
a plurality of wipers arrayed with gaps formed between sequentially adjacent ones of the wipers in the array, each of the blades aligned with a respective one of the gaps, the gaps dimensioned to closely receive the respective blades to physically engage the faces of the blade at least on movement of the plurality of blades toward the retracted position thereof from the extended position thereof.

2. The apparatus of claim 1 wherein the blades each comprise a metal and the wipers each comprise a food grade polymer.

3. The apparatus of claim 1 wherein the transmission is coupled to drive the plurality of blades as a single assembly between the retracted and the extended positions.

4. The apparatus of claim 1, further comprising:
a plurality of plates arrayed with gaps formed between sequentially adjacent metal plates in the array, and wherein each of the wipers is physically detachably coupled to a respective one of the plates.

5. The apparatus of claim 4 wherein each of the plates is a stainless steel plate and each of the wipers is a silicone wiper.

6. The apparatus of claim 1 wherein at least two of the blades are parallel to one another.

7. The apparatus of claim 1 wherein the blades extend radially away from a central axis and are angularly arrayed about the central axis, the wipers are radially arrayed with gaps formed between sequentially adjacent ones of the wipers in the array, and the plates are radially arrayed with gaps formed between sequentially adjacent metal plates in the array.

8. The apparatus of claim 7 wherein each wiper of the plurality of wipers has a triangular profile with a first set of dimensions, and each plate of the plurality of plates has a triangular profile with a second set of dimensions, the dimensions of the second set of dimensions smaller than corresponding ones of the dimensions of the first set of dimensions.

9. The apparatus of claim 1 wherein each wiper of the plurality of wipers has a first face and a second face opposed across a thickness of the wiper from the first face, and the pair of faces of each of the wipers is perpendicular to an axis along which the plurality of blades moves between the retracted position and the extended position.

10. The apparatus of claim 1 wherein each wiper of the plurality of wipers has a first face and a second face opposed across a thickness of the wiper from the first face, and at least one of the faces of each of the wipers is orientated at an angle to an axis along which the plurality of blades moves between the retracted position and the extended position, where the angle is greater than zero degrees and less than ninety degrees.

11. The apparatus of claim 4 wherein each plate has a first face and a second face opposed across a thickness of the plate from the first face, and the first face of each of the plates is perpendicular and adjacent to the second faces of a respective one of the wipers.

12. The apparatus of claim 7 wherein the plurality of blades includes a first blade that extends through the central axis, and at least a second blade that extends through the central axis, the first and the second blades each having a respective length, the lengths of the first and second blades equal to one another.

13. The apparatus of claim 12 wherein the plurality of blades includes at least a third blade that extends through the central axis, the third blade having a length, the length of the third blade equal to the lengths of the first and the second blades.

14. The apparatus of claim 13 wherein the first, the second and the third blades are nested in one another and a respective bottom-most edge of each of the first, the second and the third blades are coplanar with one another.

15. The apparatus of claim 14 wherein a respective bottom-most edge of each of the first, the second and the third blades resides in a plane that is perpendicular to a direction of motion of the first, the second and the third blades.

16. The apparatus of any of claim 7 wherein the plurality of blades includes a first blade that extends outwardly from the central axis without passing through the central axis, and at least a second blade that extends outwardly from the central axis without passing through the central axis and which is diametrically opposed across the central axis from the first blade, the first and the second blades each having a respective length, the lengths of the first and second blades equal to one another.

17. The apparatus of claim 7 wherein at least one blade of the plurality of blades is curved about the central axis.

18. The apparatus of claim 7 wherein at least one blade of the plurality of blades is curved about an axis that is perpendicular to the central axis.

19. The apparatus of claim 1, further comprising:
a frame that supports the plurality of blades and the plurality of wipers above a horizontal surface.

20. The apparatus of claim 19, further comprising:
a base to support a food item to be cut, the base positionable relatively below the plurality of blades at the extended position of the blades, the base including a number of registration features.

21. The apparatus of claim 20, further comprising:
a tray to support a food item to be cut, the tray positionable on the base and spaced relatively below the plurality of blades at the extended position of the blades.

22. The apparatus of claim 21 wherein the tray includes a number of registration features complementary to the registration features of the plate.

23. The apparatus of claim 22 wherein the tray includes a plurality of channels angularly arrayed about an axis in alignment with respective ones of the blades when the registration features of the tray physically engage the complementary registration features of the base.

24. The apparatus of claim 1, further comprising:
a piston physically coupled to drive the plurality of blades between the retracted and the extended positions via the transmission at an extended position of the plurality of blades.

25. The apparatus of claim 1, further comprising:
an electric motor physically coupled to drive the plurality of blades between the retracted and the extended positions via the transmission.

26. The apparatus of claim 1, further comprising:
a first user engagable input component; and
a second user engagable input component spaced from the first user engagable input component by a distance that prevents the first and the second user engagable input components from being concurrently operated by a single hand of a user,
the first and the second user engagable input components operably coupled to cause movement of the plurality of blades in response to concurrent engagement of both the first and the second user engagable input components by respective hands of the user.

27. The apparatus of claim 1 in which each of the blades in the plurality of blades has a cutting edge and the cutting edges of the plurality of blades form a plane, wherein at least one of the blades is non-linear.

28. The apparatus of claim 26 in which at least one of the non-linear blades forms at least one of a letter, logo, or geometrical pattern that is not a line.

29.-46. (canceled)
